(19) United States
(12) Patent Application Publication
(10) Pub. No.: US 2011/0199360 A1
(43) Pub. Date: Aug. 18, 2011

(54) Differential amplifier architecture adapted to input level conversion

(75) Inventor: Hirofumi Fujiwara, Kanagawa (JP)

(73) Assignee: Renesas Electronics Corporation, Kawasaki (JP)

(21) Appl. No.: 12/929,663

(22) Filed: Feb. 7, 2011

(30) Foreign Application Priority Data
Feb. 12, 2010 (JP) 2010-028435

(51) Int. Cl. G09G 3/36; G06F 3/038

(52) U.S. Cl. 345/211; 345/98

(57) ABSTRACT

A source driver is provided with: a D/A converter outputting a gray-level voltage corresponding to pixel data; and a source amplifier outputting a drive voltage in response to the gray-level voltage. The source amplifier includes: an NMOS differential pair including first and second NMOS transistors; a PMOS differential pair including first and second PMOS transistors; an output circuitry outputting a drive voltage in response to currents flowing through the NMOS and PMOS differential pairs; a first input level conversion circuit generating a first level-converted voltage through input level conversion on the gray-level voltage in response to the gray-level voltage and/or a polarity of the drive voltage defined with respect to a common level on an opposite electrode of a liquid crystal display panel and feeding the first level-converted voltage to gates of the first NMOS transistor and the first PMOS transistor; and a second input level conversion circuit generating a second level-converted voltage through input level conversion on the drive voltage in response to the gray-level voltage and/or the polarity of the drive voltage and feeding the second level-converted voltage to gates of the second NMOS transistor and the second PMOS transistor.

### INCORPORATION BY REFERENCE

This application claims the benefit of priority based on Japanese Patent Application No. 2010-028435, filed on Feb. 12, 2010, the disclosure of which is incorporated herein by reference.

### BACKGROUND OF THE INVENTION

1. Field of the Invention

The present invention relates to a source driver and a liquid crystal display device incorporating the same, and more particularly relates to source amplifier architecture in a source driver for driving a liquid crystal display panel.

2. Description of the Related Art

In recent years, liquid crystal display devices used in televisions and personal computer monitors have been increased in the size and definition. This requires a source driver which drives greater capacitive loads (such as source electrodes) within a liquid crystal display panel in a liquid crystal display device at high speed with reduced power consumption. In particular, the number of gray-levels is increased in a high-definition color liquid crystal display panel; recent liquid crystal display devices support 1,670,000-color display, in which each gray-level of red, green and blue is represented by 8-bit data, while conventional liquid crystal display devices only support 260,000-color display, in which each gray-level is represented by 6-bit data.

In general, a source driver drives source electrodes (data lines) of the liquid crystal display panel with differential amplifiers. Specifically, gamma voltages applied from outside are subjected to voltage division with resistors to generate gray-level voltages corresponding to allowed grayscale levels of the liquid crystal pixels, respectively, and the gray-level voltages are selected by D/A converters. The selected gray-level voltages are inputted to the differential amplifiers configured as voltage followers which provide impedance conversion. The outputs of the differential amplifiers are connected to the source electrodes of the liquid crystal display panel, and the differential amplifiers drive respective pixels of the liquid crystal display panel with drive voltages having substantially same voltage levels as the selected gray-level voltages. Differential amplifiers which are integrated within a source driver to drive source electrodes of a liquid crystal display panel are often referred to as source amplifiers. The source amplifiers may also provide fine adjustments of the drive voltages.

FIG. 1 shows an exemplary circuit configuration of a differential amplifier used as the source amplifier. The differential amplifier shown in FIG. 1 is a so-called rail-to-rail amplifier and depicted as a typical circuit in textbooks, famous documents and the like (See Japanese Patent Application Publications Nos. P2007-202127A and P2006-94534A, for example). The differential amplifier shown in FIG. 1 is schematically provided with an input stage 101, an intermediate stage 2 and an output stage 3. FIG. 2 is a simplified illustration of the circuit shown in FIG. 1.

The input stage 101 is provided with PMOS transistors MP11, MP12, NMOS transistors MN11, MN12 and current sources I11 and I12. The PMOS transistors MP11 and MP12 form a PMOS differential pair, and the NMOS transistors MN11 and MN12 form an NMOS differential pair. The sources of the PMOS transistors MP11 and MP12 are commonly connected to the current source I12, and the sources of the NMOS transistors MN11 and MN12 are commonly connected to the current source I11. The PMOS transistor MP11 and the NMOS transistor MN11 have gates commonly-connected to an input terminal IN11, and the PMOS transistor MP12 and the NMOS transistor MN12 have gates commonly-connected to an input terminal IN12. It should be noted here that the input stage 101, which includes both of the PMOS and NMOS differential pairs, provides a rail-to-rail operation. The current source I11 has a function for supplying a bias current to the NMOS differential pair and includes an NMOS transistor which has a gate supplied with a bias voltage BN1. The current source I12, on the other hand, has a function for supplying a bias current to the PMOS differential pair and includes a PMOS transistor having a gate supplied with a bias voltage BP1.

The intermediate stage 2 and the output stage 3 function as an output circuitry for outputting an output voltage from the amplifier output OUT in response to the currents through the PMOS transistors MP11, MP12 and the NMOS transistors MN11 and MN12. In detail, the intermediate stage 2 includes PMOS transistors MP43 to MP48 and NMOS transistors MN43 to MN48. A bias voltage BP2 is supplied to the PMOS transistors MP45 and MP46, and a bias voltage BN2 is supplied to the NMOS transistors MN45 and MN46. Moreover, bias voltages BP3 and BP4 are supplied to the PMOS transistors MP47 and MP48, respectively, and bias voltages BN3 and BN4 are supplied to the NMOS transistors MN47 and MN48, respectively. The PMOS transistors MP43 to MP46 form a first folded cascode current mirror, and the NMOS transistors MN43 to MN46 form a second folded cascode current mirror. On the other hand, the PMOS transistor MP47 and the NMOS transistor MN47 form a first floating current source, and the PMOS transistor MP48 and the NMOS transistor MN48 form a second floating current source. That is, the intermediate stage 2 is provided with a folded cascode current mirror composed of the PMOS transistors, a folded cascode current mirror composed of the NMOS transistors, and two floating current sources provided between the current mirrors.

The output stage 3 is provided with: a PMOS transistor MP49 connected between the amplifier output OUT and a positive power source line to which a positive power source voltage VDD is supplied; and an NMOS transistor MN49 connected between the amplifier output OUT and a negative power source line to which a negative power source voltage (ground voltage) VSS is supplied. The amplifier output OUT is connected to the input terminal IN12 of the input stage 101. In addition, a capacitive element C₁ is connected between the amplifier output OUT and the source of the PMOS transistor MP46 (the drain of the MP44) for phase compensation, and a capacitive element C₂ is connected between the amplifier output OUT and the source of the NMOS transistor MN46 (the drain of the MN44) for phase compensation.

The differential amplifier having the above-described configuration forms a voltage follower, and a voltage approximately coincident with the voltage supplied to the input terminal IN11 is outputted from the amplifier output OUT. FIG. 2 is a schematic diagram showing the configuration of the differential amplifier shown in FIG. 1 for easy understanding.

In the following, a description is given of the allowed input voltage range of the differential amplifier shown in FIG. 1 (FIG. 2), referring to FIG. 3. In order to attain the rail-to-rail operation, the input stage 101 includes both of the NMOS differential pair (namely, the NMOS transistors MN11, MN12) and the PMOS differential pair (namely, the PMOS transistors MP11, MP12). When a voltage VIN11 inputted to the input terminal IN11 is in a range close to the negative power source voltage VSS, the PMOS differential pair (MP11, MP12) operates, and both of the PMOS and NMOS transistor differential pairs operate when the voltage VIN11 in the middle voltage range. Also, when the voltage VIN11 is in a range close to the positive power source voltage VDD, only the NMOS differential pair (MN11, MN12) operates. Accordingly, the input stage 101 of the differential amplifier in FIG. 1 is operated in the entire input voltage range from the negative power source voltage VSS to the positive power source voltage VDD.

When a liquid crystal display panel is driven, the application of a direct current voltage may cause deterioration of the liquid crystal, depending on the characteristics of the liquid crystal. Thus, an alternating voltage is applied to each pixel to avoid the liquid crystal being deteriorated. For this reason, polarities of the drive voltages of the liquid crystal display panel are switched. In a case of a so-called common constant drive, a common voltage V_{COM} of about VDD/2 is applied to the common electrode (opposite electrode) of the liquid crystal display panel. Hereinafter, a drive voltage in a range between the negative power source voltage VSS and the common voltage V_{COM} is referred to as a negative drive voltage and a drive voltage in a range between the common voltage V_{COM} and the positive power source voltage VDD is referred to as a positive drive voltage. In a liquid crystal display device having a typical configuration, a polarity signal (often, denoted by symbol POL) is supplied to each source driver to specify the polarity of the respective drive voltages.

It should be noted that, in an actual panel drive, the input voltage inputted to the source amplifier are not set to the positive power source voltage VDD, the voltage VDD/2 equal to half thereof, or the negative power source voltage VSS. An input voltage in a range from VSS+α to VDD/2−α is inputted for outputting a negative drive voltage, and an input voltage in a range from VDD/2+α to VDD−α is inputted for outputting a positive drive voltage. The offset voltage a typically ranges from 0.1 V to 0.2 V in a currently used panel. It should be noted that, in the following, the offset voltage a of the input voltage is basically omitted for simplicity in describing the allowed range of the input voltage; the allowed range of the input voltage are defined only with the negative power source voltage VSS, VDD/2 and the positive power source voltage VDD.

An input voltage of about VDD/2−VGM is fed to a source amplifier which outputs a negative drive voltage, and this source amplifier outputs an output voltage corresponding to the input voltage fed thereto, where VGM is a gray-level voltage required to set a certain pixel to a particular gray-level (namely, a voltage applied between the pixel electrode in the pixel and the opposite electrode). On the other hand, an input voltage of about VDD/2+VGM is fed to a source amplifier which outputs a positive drive voltage, and this source amplifier outputs an output voltage corresponding to the input voltage fed thereto. The difference between the output voltage V_{OUTP} actually outputted when the input voltage is VDD/2+VGM and the output voltage V_{OUTN} actually outputted when the input voltage is VDD/2−VGM is referred to as peak-to-peak voltage (Vpp), and variations in the peak-to-peak voltages of amplifiers are referred to as peak-to-peak voltage variations. In order to improve the accuracy of a drive voltage (namely, in order to actually output a desired drive voltage), the peak-to-peak voltage variations are desired to be 0 V.

Although reduced peak-to-peak voltage variations are obtained in the configuration of FIG. 1 (and FIG. 2) in a case that the input voltage is in a middle voltage range away from the ground voltage VSS and the power source voltage VDD, the peak-to-peak voltage variations are increased in a voltage range close to the power source voltage VDD and a voltage range close to the ground voltage VSS. The reason will be discussed in the following.

As shown in FIG. 3, for an input voltage VIN11 in a voltage range close to the negative power source voltage VSS (0 V), only the PMOS differential pair (MP11, MP12) operates in the differential amplifier in FIG. 1; the NMOS differential pair (MN11, MN12) does not operate. This is because the operation of the NMOS transistors MN11 and MN12, which form the NMOS differential pair, requires the input voltage VIN11 supplied to the gates of the NMOS transistors MN11 and MN12 to exceed the sum of the threshold voltage VT(MN11) (=VT(MN12)) of the NMOS transistors MN11 and MN12 and the drain-to-source voltage VDS(I11) of the NMOS transistor, which forms the current source I11. It should be noted here that enhancement-types are usually used as NMOS transistors integrated within an integrated circuit. When the input voltage VIN11 is close to the negative power source voltage VSS (namely, when the gate voltages of the NMOS transistors MN11 and MN12 are close to the negative power source voltage VSS), however, the source voltages of the NMOS transistors MN11 and MN12 are also close to 0 V, resulting in that that the NMOS differential pair consisting of the NMOS transistors MN11 of MN12 does not operate. In FIG. 3, the lower limit value VT(MN11)+VDS(I11) at which the NMOS transistor MN11 operates is illustrated as the lower dotted line.

When the input voltage is in a voltage range close to the power source voltage VDD (namely, when the gate voltages of the respective transistors in the PMOS differential pair are close to the power source voltage VDD), on the other hand, the source voltages are also close to the power source voltage VDD, resulting in that the PMOS differential pair (MP11, MP12) does not operate. In FIG. 3, the upper limit value (VDD−VDS(I12)−VT(MP11)) at which the PMOS transistor MP11 operates is illustrated as the upper dotted line, where VDS(I12) is the drain-to-source voltage of the PMOS transistor forming the current source I12, and VT(MP11) is the threshold voltage of the PMOS transistor MP11.

When the input voltage VIN11 is in a range between VT(MN11)+VDS(I11) and VDD−VDS(I12)−|VT(MP11)| (namely, when the input voltage VIN11 is in the middle voltage range), both of the PMOS differential pair (MP11, MP12) and the NMOS differential pair (MN11, MN12) operate. When the gray-level voltage VGM is small (namely, when the input voltage VIN11 is in the middle voltage range), the peak-to-peak voltage variations are advantageously reduced since offset voltages of the PMOS differential pair (MP11, MP12) and the NMOS differential pair (MN11, MN12) are cancelled. The cancellation of the offset voltages will be described below with reference to FIGS. 4A and 4B.

For a certain amplifier output OUT_1, let us define “offset1” as an input-to-output offset of the corresponding source amplifier from the desired values V_{OUTP}* and V_{OUTN}* of the positive and negative drive voltages. When the input voltage VIN11 is in the middle voltage range, the input-to-output offset offset1 has a value determined on the operations of both of the PMOS differential pair (MP11, MP12) and the NMOS differential pair (MN11, MN12).

In the middle voltage range, both of the differential pairs operate and thus the input-to-output offset offset1 is unchanged between a case that the positive drive voltage is outputted and a case that the negative drive voltage is outputted.

Accordingly, the peak-to-peak voltage Vpp_1 of the amplifier output OUT_1 is represented as follows:

Vpp_{—}1=(V_{OUTP}*+offset1)−(V_{OUTN}*+offset1),

for a case that the input-to-output offset of the amplifier output OUT_1 has a positive value with respect to the desired drive voltages, where V_{OUTP}* is the desired value of the positive drive voltage to be outputted, and V_{OUTN}* is the desired value of the negative drive voltage to be outputted. As is understood from the fact that offset1 is cancelled in the above equation, the peak-to-peak voltage Vpp_1 of the amplifier output OUT_1 is finally obtained as V_{OUTP}*−V_{OUTN}*.

For another amplifier output OUT_3, let us define “offset2” as the offset voltage thereof. When offset2 has a negative value with respect to the desired output voltage, the peak-to-peak voltage Vpp_3 of the amplifier output OUT_3 for the same desired output voltage is represented as follows:

Vpp_{—}3=(V_{OUTP}*+offset2)−(V_{OUTN}*+offset2).

Similarly to the amplifier output OUT_1, the offset2 is cancelled, and the peak-to-peak voltage Vpp_3 of the amplifier output OUT_3 is finally obtained as V_{OUTP}*−V_{OUTN}*.

As thus discussed, the peak-to-peak voltages Vpp of the amplifier outputs OUT_1 and OUT_3 are both V_{OUTP}*−V_{OUTN}*, and the peak-to-peak voltage variation between the amplifier outputs OUT_1 and OUT_3 is 0 V. That is, when the input voltage VIN11 is in the middle voltage range, reduced peak-to-peak voltage variations are obtained.

When the gray-level voltage VGM is high, (namely, when the input voltage VIN11 is close to the negative power source voltage VSS or close to the positive power source voltage VDD), on the other hand, only one of the PMOS differential pair (MP11, MP12) and the NMOS differential pair (MN11, MN12) is operates, and the input-to-output offset is not cancelled. This undesirably increases the peak-to-peak voltage variations. Such increase in the peak-to-peak voltage variations will be discussed in the following with reference to FIG. 4B.

For the amplifier output OUT_1, let us define “offset1” as the input-to-output offset of the source amplifier from the desired value V_{OUTP}* of the positive drive voltage, and define “offset2” as the input-to-output offset of the source amplifier from the desired value V_{OUTN}* of the negative drive voltage to be outputted. The input-to-output offset “offset1” is the value for the case that only the NMOS differential pair (MN11, MN12) operates, and the input-to-output offset offset2 is the value for the case that only the PMOS differential pair (MP11, MP12) operates. Thus, the input-to-output offsets offset1 and offset2 have different values.

In one example, when the input-to-output offset offset1 of the amplifier output OUT_1 is positive with respect to the desired value V_{OUTP}* of the positive drive voltage and the input-to-output offset offset2 is negative with respect to the desired value V_{OUTN}* of the positive drive voltage, the peak-to-peak voltage Vpp_1 of the amplifier output OUT_1 is represented as follows:

Vpp_{—}1=V_{OUTP}*+offset1−V_{OUTN}*−offset2.

In this equation, the input-to-output offsets offset1 and offset2 are not cancelled, since the input-to-output offsets offset1 and offset2 have different values.

Similarly, let us define “offset3” and “offset4” as the input-to-output offsets for the amplifier output OUT_3. When the output offset offset3 is negative with respect to the desired value V_{OUTP}* of the positive drive voltage and the input-to-output offset offset4 is positive with respect to the desired value V_{OUTN}* of the negative drive voltage, the peak-to-peak voltage Vpp_3 of the amplifier output OUT_3 is represented as follows:

Vpp_{—}3=V_{OUTP}*−offset3−V_{OUTN}*−offset4.

Similarly to the amplifier output OUT_1, the input-to-output offsets offset3 and offset4 are not cancelled.

As thus discussed, the input-to-output offsets offset1, offset2, offset3 and offset4 are not cancelled for both of the amplifier outputs OUT_1, OUT_3, and the peak-to-peak voltages Vpp of the amplifier outputs OUT_1 and OUT_3 have different values. This results in that the peak-to-peak voltage variations are increased, making it difficult to attain higher definition of the drive voltages.

### SUMMARY

In an aspect of the present invention, a source driver for driving a liquid crystal display panel is provided. The source driver is provided with: a D/A converter outputting a gray-level voltage corresponding to pixel data; and a source amplifier outputting a drive voltage in response to the gray-level voltage. The source amplifier includes: an NMOS differential pair including first and second NMOS transistors; a PMOS differential pair including first and second PMOS transistors; an output circuitry outputting a drive voltage in response to currents flowing through the NMOS and PMOS differential pairs; a first input level conversion circuit generating a first level-converted voltage through input level conversion on the gray-level voltage in response to the gray-level voltage and/or a polarity of the drive voltage defined with respect to a common level on an opposite electrode of the liquid crystal display panel and feeding the first level-converted voltage to gates of the first NMOS transistor and the first PMOS transistor; and a second input level conversion circuit generating a second level-converted voltage through input level conversion on the drive voltage in response to the gray-level voltage and/or the polarity of the drive voltage and feeding the second level-converted voltage to gates of the second NMOS transistor and the second PMOS transistor.

The present invention effectively improves the peak-to-peak voltage variations of the source amplifier in the source driver.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a circuit diagram showing an exemplary configuration of a conventional source amplifier;

FIG. 2 is a schematic view showing the configuration of the conventional source amplifier;

FIG. 3 is a graph showing the relation between the input voltage and the gate voltages of transistors in the differential pair in the conventional source driver;

FIG. 4A is a graph showing a peak-to-peak voltage variation when the input voltage is in a middle voltage range, in the conventional source amplifier;

FIG. 4B is a graph showing a peak-to-peak voltage variation when the input voltage is close to the positive power source voltage or the negative power source voltage, in the conventional source amplifier;

FIG. 5A is a block diagram showing an exemplary configuration of a liquid crystal display device in a first embodiment of the present invention;

FIG. 5B is a block diagram showing an exemplary configuration of a source driver in the first embodiment;

FIG. 5C is a circuit diagram showing an exemplary configuration of a source amplifier in the first embodiment;

FIG. 6 is a graph showing an exemplary relation between an input voltage and gate voltages of transistors in a differential pair, in the first embodiment;

FIG. 7A is a graph showing a simulation result of input-to-output offsets of the source amplifiers in the conventional circuit and the first embodiment;

FIG. 7B is a graph showing a simulation result of amplitude differences of the source amplifiers in the conventional circuit and the first embodiment;

FIG. 8A is a graph showing a simulation result of peak-to-peak voltage variations of the conventional circuit;

FIG. 8B is a graph of a simulation result of peak-to-peak voltage variations of the source amplifier in this embodiment;

FIG. 9A is a block diagram showing an exemplary configuration of a source driver in a second embodiment of the present invention;

FIG. 9B is a circuit diagram showing an exemplary configuration of a source amplifier in the second embodiment;

FIG. 10 is a graph showing an exemplary relation between an input voltage and gate voltages of transistors in a differential pair, in the second embodiment;

FIG. 11 is a circuit diagram showing an exemplary configuration of a source amplifier in a third embodiment;

FIG. 12 is a graph showing an exemplary relation between an input voltage and gate voltages of transistors in a differential pair;

FIG. 13 is a circuit diagram showing an exemplary configuration of a source amplifier in a fourth embodiment; and

FIG. 14 is a graph showing an exemplary relation between an input voltage and gate voltages of transistors in a differential pair, in the fourth embodiment.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

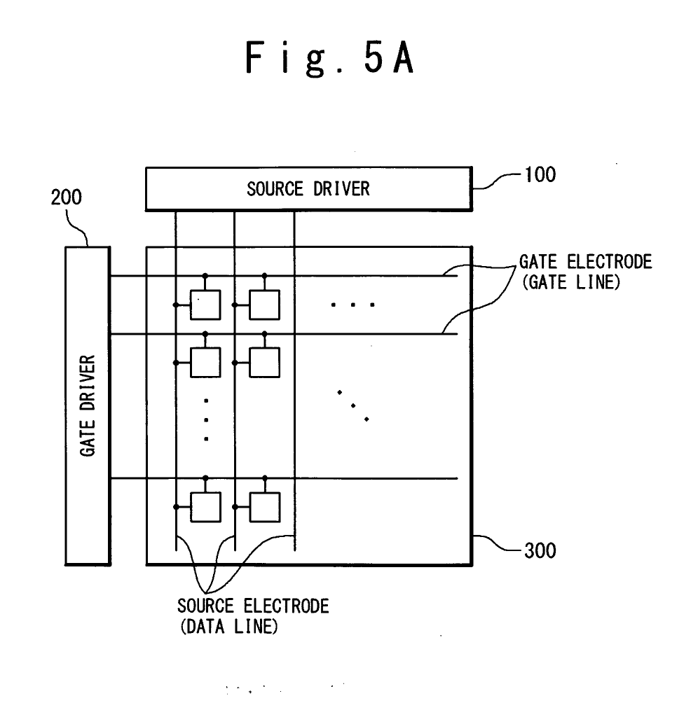

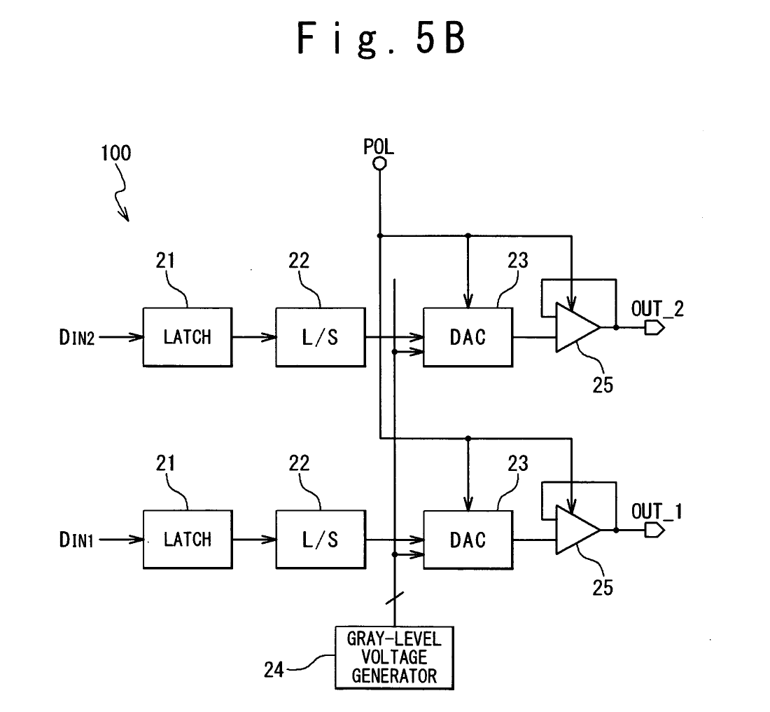

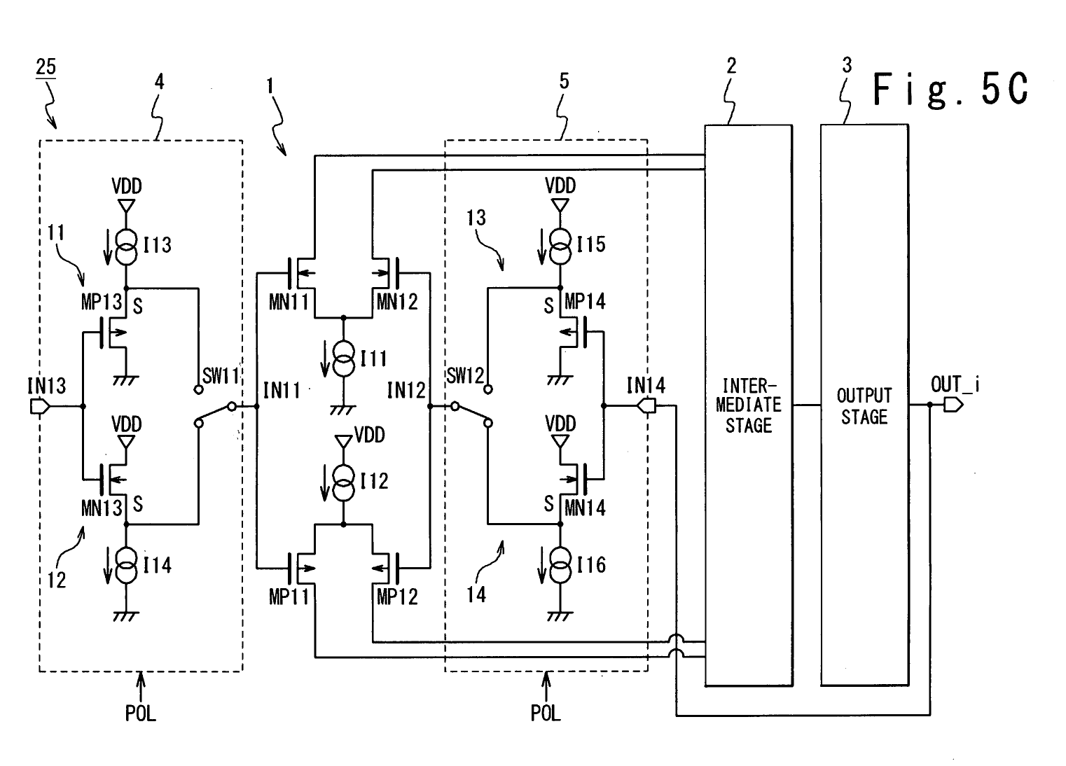

FIG. 5A is a block diagram showing an exemplary configuration of a liquid crystal display device in a first embodiment of the present invention. The liquid crystal display device of this embodiment is provided with a source driver 100, a gate driver 200 and a liquid crystal display panel 300. The source driver 100 drives source electrodes (data lines) within the liquid crystal display panel 300. The gate driver 200 drives gate electrodes (gate lines) in the liquid crystal display panel 300. Pixels are provided respective intersections of the source electrodes and the gate electrodes within the liquid crystal display panel 300.

FIG. 5B is a block diagram showing an exemplary configuration of the source driver 100 in the first embodiment. FIG. 5B shows a circuit portion of the source driver 100 which drives two source electrodes (data lines) in the liquid crystal display panel 300.

The source driver 100 is provided with latches 21, level shifters 22, D/A converters 23, a gray-level voltage generator circuit 24 and source amplifiers 25. The latch 21 receives a pixel data D_{IN} and supplies through the level shifter 22 to the D/A converter 23. In FIG. 5B, symbols OUT_1 and OUT_2 denote two amplifier outputs OUT and symbols “D_{IN1}” and “D_{IN2}” denote the pixel data D_{IN} corresponding to the amplifier outputs OUT_1 and OUT_2, respectively. The level shifters 22 provide signal level conversion to achieve signal level matching between the latches 21 and the D/A converters 23. The gray-level voltage generator circuit 24 supplies a set of gray-level voltages which correspond to the respective allowed gray-levels of the pixels within the liquid crystal display panel 300, to the D/A converters 23. The gray-level voltages supplied to the D/A converters 23 include positive gray-level voltages (the gray-level voltages higher than the common voltage V_{COM}) and the negative gray-level voltages (the gray-level voltages lower than the common voltage V_{COM}). The D/A converters 23 select the gray-level voltages corresponding to the pixel data D_{IN1} and D_{IN2} received from the latches 21 out of the gray-level voltages received from the gray-level voltage generator circuit 24, and output the selected gray-level voltages to the source amplifiers 25. The source amplifiers 25 are formed as a voltage follower and output voltages approximately equal to the gray-level voltages received from the D/A converter 23 as the drive voltages from the amplifier outputs OUT_1 and OUT_2. The amplifier outputs OUT_1 and OUT_2 are connected to the source electrodes (data lines) of the liquid crystal display panel 300. Then, the drive voltages outputted from the amplifier outputs OUT_1 and OUT_2 are supplied to desired pixels in the liquid crystal display panel 300 to drive the pixels.

The D/A converters 23 select the polarities of the selected gray-level voltages in response to a polarity signal POL. It should be noted here that the polarity signal POL is a signal which specifies the polarities of the drive voltages to be outputted from the respective source amplifiers 25 in the source driver 100, as mentioned above. When the source driver 100 carries out a line inversion drive, for example, the D/A converters 23 and the source amplifiers 25 operate as follows: When the polarity signal POL is set to “H”, all of the D/A converters 23 output the positive gray-level voltages, and all of the source amplifiers 25 output the positive drive voltages in response to the positive gray-level voltages received from the D/A converters 23. When the polarity signal POL is set to “L”, on the other hand, all of the D/A converters 23 output the negative drive voltages, and all of the source amplifiers 25 output the negative drive voltages in response to the negative gray-level voltages received from the D/A converters 23. On the other hand, when the source driver 100 carries out a dot inversion drive, in response to the polarity signal POL, one of every two adjacent D/A converters 23 outputs a positive gray-level voltage and the other outputs a negative gray-level voltage. In response thereto, one of every two adjacent source amplifiers 25 outputs the corresponding positive drive voltage, and the other outputs the corresponding negative drive voltage.

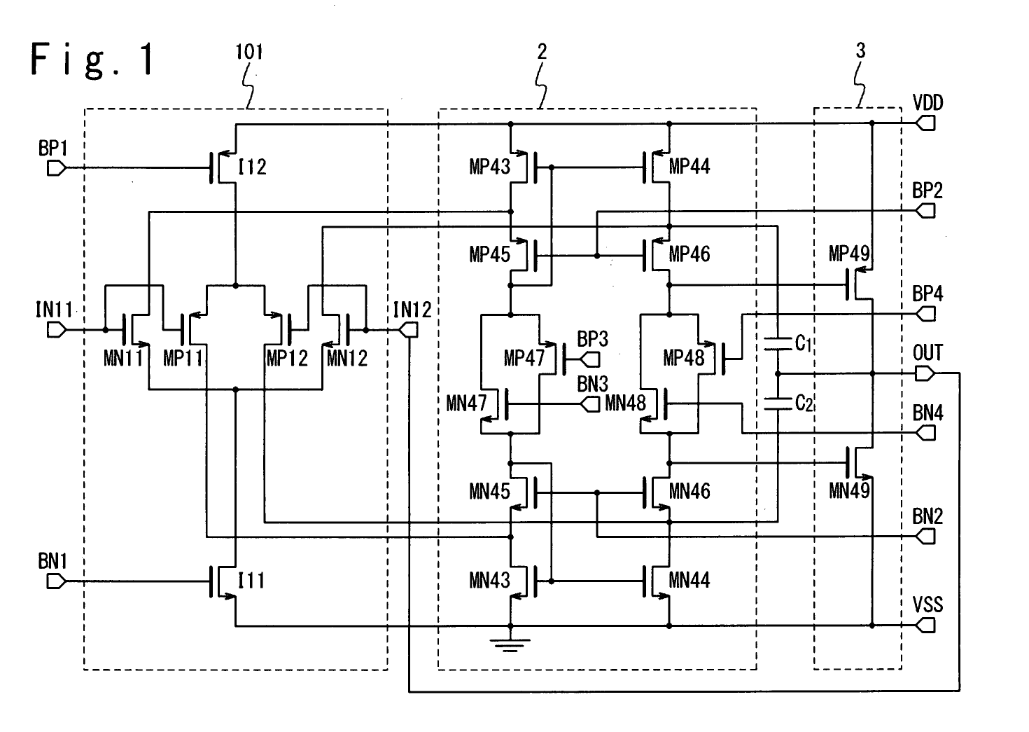

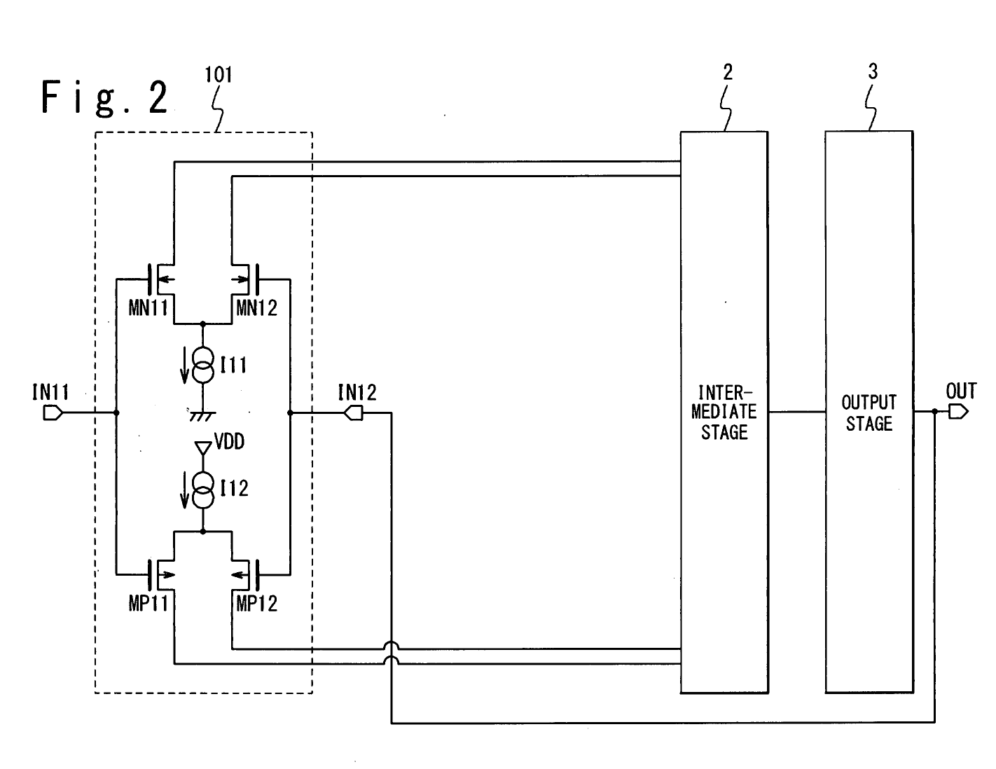

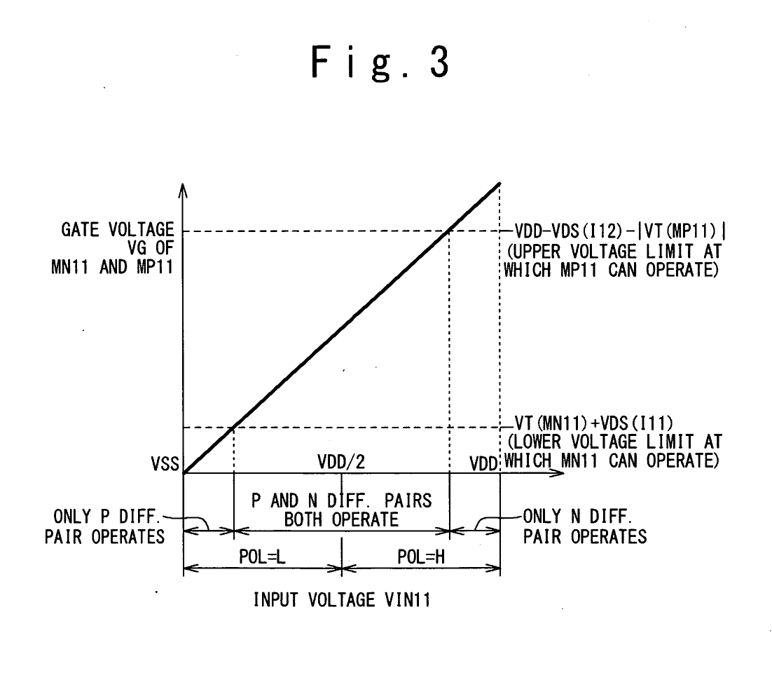

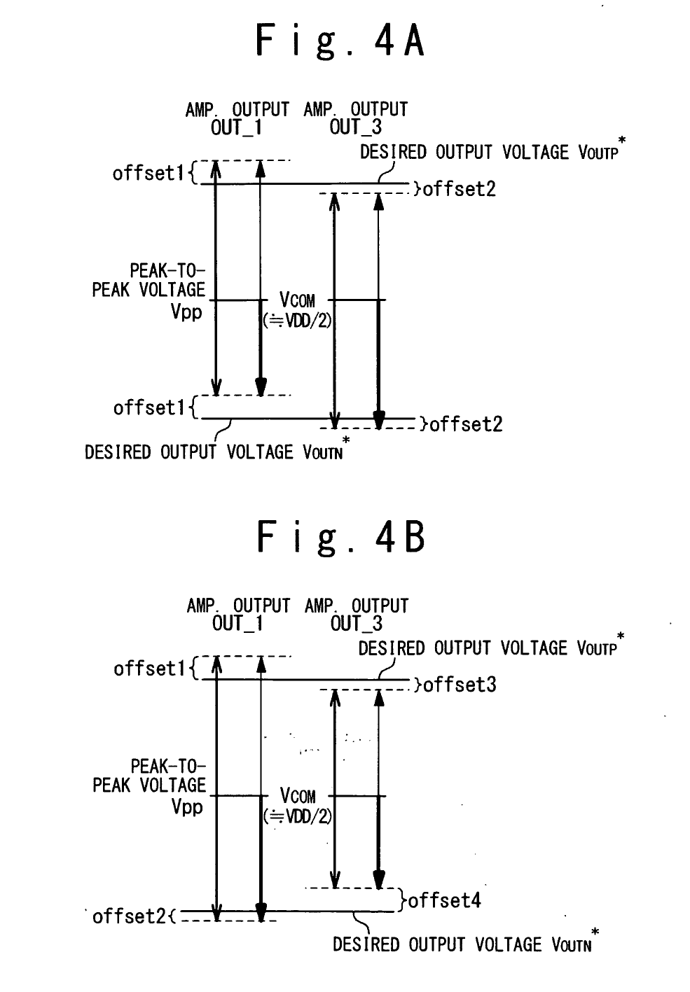

FIG. 5C is a circuit diagram showing an exemplary configuration of the source amplifiers 25 in this embodiment. The source amplifiers 25 in the first embodiment are configured so that the input stage 101 is replaced with an input stage 1, as compared with the conventional circuit in FIG. 1; the configurations of the intermediate stage 2 and the output stage 3 are same as those shown in FIG. 1. A gray-level voltage selected by a D/A converter 23 is supplied to the input terminal IN13. That is, the input voltage VIN13 on the input terminal IN13 is identical to the gray-level voltage selected by the D/A converter 23. Also, the output terminal of the output stage 3 (namely, the amplifier output OUT) is connected to the input terminal IN14 to thereby achieve feed-back of the drive voltage outputted by the amplifier output OUT to the input stage 1.

The input stage 1 is provided with NMOS transistors MN11 and MN12 forming an NMOS differential pair, PMOS transistors MP11 and MP12 forming a PMOS differential pair, and a current source I12. The dimensions of the NMOS transistors MN11 and MN12 are equal, and the dimensions of the PMOS transistors MP11 and MP12 are equal. The sources of the NMOS transistors MN11 and MN12 are commonly connected to the current source I11, and the gates of the NMOS transistors MN11 and MN12 are connected to input nodes IN11 and IN12, respectively. The drains of the NMOS transistors MN11 and MN12 are connected to the sources of PMOS transistors MP45 and MP46 of the intermediate stage 2, respectively. On the other hand, the sources of the PMOS transistors MP11 and MP12 are commonly connected to the current source I12, and the gates of the PMOS transistors MP11 and MP12 are connected to the input nodes IN11 and IN12, respectively. The drains of the PMOS transistors MP11 and MP12 are connected to the sources of the NMOS transistors MN45, MN46 of the intermediate stage 2, respectively.

The input stage 1 further includes input level conversion circuits 4 and 5. The input level conversion circuits 4 and 5 perform input level conversions on the input voltages inputted to the input terminals IN13 and IN14, respectively. The input level conversions by the input level conversion circuits 4 and 5 are performed in response to the polarity signal POL.

In detail, the input level conversion circuit 4 includes a PMOS source follower 11, an NMOS source follower 12 and an input switch SW11. The PMOS source follower 11 is provided with a PMOS transistor MP13 and a bias current source I13. The NMOS source follower 12 is provided with an NMOS transistor MN13 and a bias current source I14. The gate of the PMOS transistor MP13 serves as the input of the PMOS source follower 11, and the source of the PMOS transistor MP13 serves as the output of the PMOS source follower 11. Similarly, the gate of the NMOS transistor MN13 serves as the input of the NMOS source follower 12, and the source of the NMOS transistor MN13 serves as the output of the NMOS source follower 12.

The PMOS source follower 11 outputs a voltage higher than the voltage VIN13 of the input terminal IN13 by a predetermined voltage (specifically, by the threshold voltage of the PMOS transistor MP13) from the source of the PMOS transistor MP13. The NMOS source follower 12 outputs a voltage lower than the voltage of the input terminal IN13 by a predetermined voltage (specifically, by the threshold voltage of the NMOS transistor MN13) from the source of the NMOS transistor MN13. That is, the source voltage VS(MP13) of the PMOS transistor MP13 and the source voltage VS(MN13) of the NMOS transistor MN13 are represented by the following equations:

VS(MP13)=VIN13+|VT(MP13)|, and

VS(MN13)=VIN13−|VT(MN13)|,

where VIN13 is the voltage of the input terminal IN13; |VT(MP13)| is the absolute value of the threshold voltage of the PMOS transistor MP13; and VT(MN13) is the threshold voltage of the NMOS transistor MN13.

The input switch SW11 switches the connections between the input node IN11 and the PMOS and NMOS source followers 11 and 12, in response to the polarity signal POL. Specifically, when a negative drive voltage is to be outputted (namely, a drive voltage lower than the common voltage V_{COM} is to be outputted), the input switch SW11 connects the input node IN11 to the source of the PMOS transistor MP13. When a positive drive voltage is to be outputted (namely, when a drive voltage lower than the common voltage V_{COM} is outputted), on the other hand, the input switch SW11 connects the input node IN11 to the source of the NMOS transistor MN13.

The input level conversion circuit 4 configured as described above outputs a voltage higher than the voltage VIN13 of the input terminal IN13 by |VT(MP13)|, or a voltage lower than the voltage VIN13 by VT(MN13), to the gates of the NMOS transistor MN11 and the PMOS transistor MP11, in response to the polarity signal POL.

Similarly, the input level conversion circuit 5 is provided with a PMOS source follower 13, an NMOS source follower 14 and an input switch SW12. The PMOS source follower 13 is provided with a PMOS transistor MP14 and a bias current source I15. The NMOS source follower 14 is provided with an NMOS transistor MN14 and a bias current source I16.

The PMOS source follower 13 outputs a voltage higher than the voltage of the input terminal IN14 by a predetermined voltage (specifically, by the threshold voltage of the PMOS transistor MP14) from the source of the PMOS transistor MP14. The NMOS source follower 14 outputs a voltage lower than the voltage of the input terminal IN14 by a predetermined voltage (specifically, by the threshold voltage of the NMOS transistor MN14) from the source of the NMOS transistor MN14. That is, the source voltage VS(MP14) of the PMOS transistor MP14 and the source voltage VS(MN14) of the NMOS transistor MN14 are represented by the following equations:

VS(MP14)=VIN14+|VT(MP14)|, and

VS(MN14)=VIN14−|VT(MN14)|,

where VIN14 is the voltage of the input terminal IN14; |VT(MP14)| is the threshold voltage of the PMOS transistor MP14, and VT(MN14) is the threshold voltage of the NMOS transistor MN14.

Similarly, the input switch SW12 switches the connections between the input node IN12 and the PMOS and NMOS source followers 13 and 14. Specifically, when the negative drive voltage is to be outputted, the input switch SW12 connects the input node IN12 to the source of the PMOS transistor MP14. When the positive drive voltage is outputted, on the other hand, the input switch SW12 connects the input node IN12 to the source of the NMOS transistor MN14.

The dimensions of the respective transistors within the input level conversion circuits 4 and 5 are determined as follows: First, the dimensions of the PMOS transistor MP13 are designed to satisfy the following equation.

|VT(MP13)|>VT(MN11)+VDS(I11), (1a)

where VT(MN11) is the threshold voltage of the NMOS transistor MN11, and VDS(I11) is the drain-to-source voltage of the NMOS transistor forming the current source ill. The dimensions of the PMOS transistors forming the bias current sources I13 and I15 are designed to be equal, and the dimensions of the PMOS transistors MP13 and MP14 are designed to be equal. Thus, the following equation is established at the same time:

|VT(MP14)|>VT(MN12)+VDS(I11), (1b)

Similarly, the dimensions of the NMOS transistor MN13 are designed to satisfy the following equation:

|VT(MN13)|>VT(MP11)+VDS(I12), (2a)

where VT(MP11) is the threshold voltage of the NMOS transistor MN11, and VDS(I11) is the drain-to-source voltage of the NMOS transistor forming the current source I11. The dimensions of the PMOS transistors forming the bias current sources I13 and I15 are designed to be equal, and the dimensions of the PMOS transistors MP13 and MP14 are designed to be equal. Thus, the following equation is established at the same time:

VT(MN14)>|VT(MP12)|+VDS(I12) (2b)

Next, a description is given of the operation of the source amplifiers 25 in this embodiment. Hereafter, an exemplary operation of a source amplifier 25 is described for a case that a positive drive voltage is outputted in response to the polarity signal POL being set to “H”, a negative drive voltage is outputted in response to the polarity signal POL being set to “L”. In this case, the input switches SW11 and SW12 provide connections between the input node IN11 and the source of the PMOS transistors MP13 and between the input node IN12 and the source of the PMOS transistor MP14, when the polarity signal POL is set to “L”, and provide connections between the input node IN11 and the source of the NMOS transistor MN13 and between the input node IN12 and the source of the NMOS transistor MN14, when the polarity signal POL is set to “H”. It should be noted that, in such operation, the input voltage VIN13 is lower than VDD/2 when the polarity signal POL is “L”, and the input voltage VIN1 13 is higher than VDD/2 when the polarity signal POL is “H”.

When the polarity signal POL is set to “L”, the input node IN11 is connected to the source of the PMOS transistor MP13 by the input switch SW11.

Consequently, a voltage of VIN13+|VT(MP13)| is applied to the gate of the NMOS transistor MN11 in the NMOS differential pair. Thus, even when the input voltage VIN13 is close to the negative power source voltage VSS, the voltage VIN11 of the input node IN11 is not reduced below VSS+|VT(MP13)|. The lower limit value of the voltage VIN11 of the input node IN11 at which the NMOS transistor MN11 operates is VT(MN11)+VDS(I11), whereas the voltage of VT(MN11)+VDS(I11) or more is applied to the input node IN11 as understood from the equation (1a). Thus, the NMOS transistor MN11 can operate even when the input voltage VIN13 is close to the negative power source voltage VSS.

At this time, the other NMOS transistor MN12 in the NMOS differential pair can also operate. More specifically, the input voltage VIN14 inputted to the input terminal IN14 is also close to the negative power source voltage VSS due to the feedback operation, when the input voltage VIN13 is close to the negative power source voltage VSS. Here, the input node IN12 is connected to the source of the PMOS transistor MP14 by the input switch SW12. Thus, a voltage of VIN14+|VT(MP14)| is applied to the gate of the NMOS transistor MN12 in the NMOS differential pair even when the input voltage VIN14 is close to the negative power source voltage VSS. As understood from the equation (1b), the voltage of VT(MN12)+VDS(I11) or more is also applied to the input node IN12. Hence, the NMOS transistor MN12 can operate, even when the input voltage VIN13 is close to the negative power source voltage VSS.

When the polarity signal POL is set to “H”, on the other hand, the input node IN11 is connected to the source of the NMOS transistor MN13 by the input switch SW11. Thus, a voltage of VIN13−VT(MN13) is applied to the gate of the PMOS transistor MP11 in the PMOS differential pair, even when the input voltage VIN13 is high. The upper limit value of the voltage VIN11 at which the PMOS transistor MP11 operates is VDD−VDS(I12)−|VT(MP11)|, whereas the voltage of VDD−VDS(I12)−|VT(MP11)| or less is applied to the input node IN11 as understood from the equation (2a). Thus, the PMOS transistor MP11 can operate even when the input voltage VIN13 is close to the positive power source voltage VDD. At this time, a voltage of VDD−VDS(I12)−|VT(MP12)| or less is applied to the other PMOS transistor MP12 in the PMOS differential pair, as is understood from the equation (2b). Thus, the PMOS transistor MP12 can operate even when the input voltage VIN13 is close to the positive power source voltage VDD.

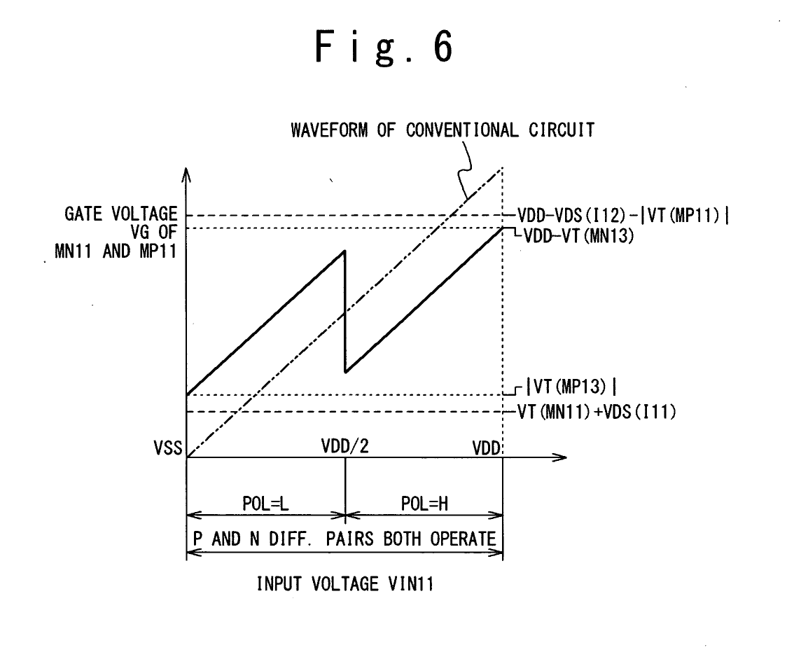

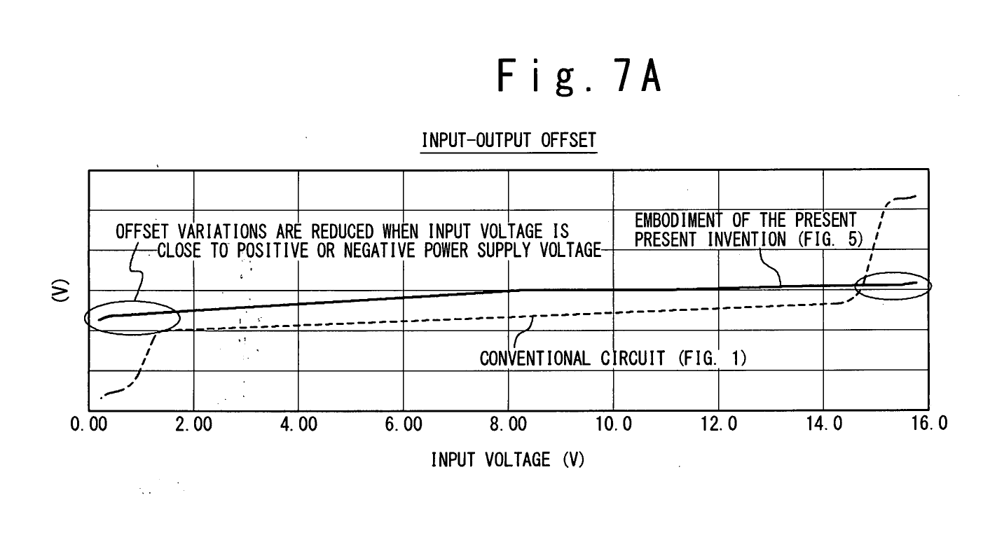

FIG. 6 is a graph showing the relation between the input voltage VIN13 and the gate voltages VG of the NMOS transistor MN11 and the PMOS transistor MP11. As shown in FIG. 6, when the polarity signal POL is set to “L” and the input voltage VIN13 is close to the negative power source voltage VSS, the gate voltage of the NMOS transistor MN11 is increased up to VIN13+|VGS(MP13)|. When the polarity signal POL is “H” and the input voltage VIN13 is close to the positive power source voltage VDD, on the other hand, the gate voltage of the PMOS transistor MP11 is decreased down to VIN13−VGS(MN13).

Thus, the gate voltages of the NMOS transistor MN11 and the PMOS transistor MP11 are always in a range between the lower limit value (indicated by the lower dotted line) at which the NMOS transistor MN11 operates and the upper limit value (indicated by the upper dotted line) at which the PMOS transistor MP11 operates, for the entire voltage range of the input voltage VIN13 between the negative power source voltage VSS and the positive power source voltage VDD. That is, in this embodiment, both of the NMOS differential pair and the PMOS differential pair can operate irrespectively of the value of the input voltage VIN13. This implies that the source amplifier 25 of this embodiment exhibits the improved peak-to-peak voltage variations, for any voltage level of the input voltage VIN13 in the voltage range between the negative power source voltage VSS and the positive power source voltage VDD.

One may consider that the configuration of the source amplifier 25 of this embodiment may cause deterioration of the linearity of the drive voltage in a voltage range around the voltage of VDD/2, since the connections of the input switches SW11 and SW12 are switched when the input voltage VIN13 is changed across the common voltage V_{COM} (≈VDD/2); however, this does not cause any problem in actual operations, because, as mentioned above, the actual input voltage VIN13 is in the voltage range between VSS+α and VDD/2−α for the polarity signal POL of “L”, and in the voltage range between VDD/2+α and VDD−α for the polarity signal POL of “H”. The voltage in the voltage range of VDD/2±α is never inputted as the input voltage VIN13. Thus, the poor linearity in the voltage range around the voltage of VDD/2 does not cause any problem.

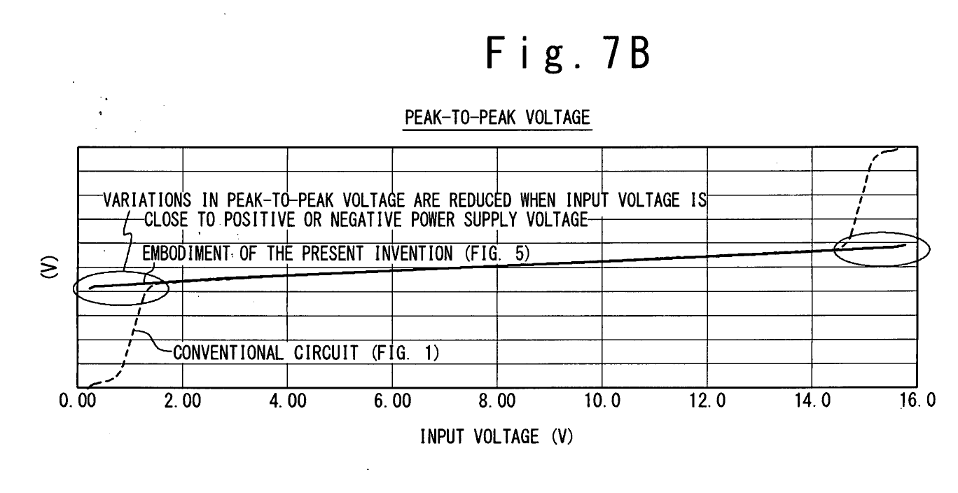

In the following, a further description is given of advantages of the source amplifier 25 of this embodiment with reference to the simulation results shown in FIGS. 7A, 7B. In FIGS. 7A, 7B, the horizontal axis indicates the input voltage VIN13, and the vertical axis indicates the input-to-output offset and the amplitude difference, respectively.

For the input-to-output offset shown in FIG. 7A, the input-to-output offset of the conventional circuit (FIG. 1) is large in the voltage regions close to the negative power source voltage VSS and the positive power source voltage VDD. On the other hand, the input-to-output offset of the circuit in this embodiment is small in the voltage regions close to the negative power source voltage VSS and the positive power source voltage VDD, as is the case of the middle voltage range.

FIG. 7B shows the amplitude difference of the source amplifier, namely, the difference between the desired value Vpp*(=V_{OUTP}*−V_{OUTN}*) of the peak-to-peak voltage Vpp and the calculated peak-to-peak voltage Vpp obtained by a simulation. The conventional circuit shown in FIG. 1 exhibits an increased amplitude difference in the voltage ranges close to the negative power source voltage VSS and the positive power source voltage VDD, whereas the source amplifier 25 of this embodiment exhibits a reduced amplitude difference in those voltage ranges, as is the case of the middle voltage range.

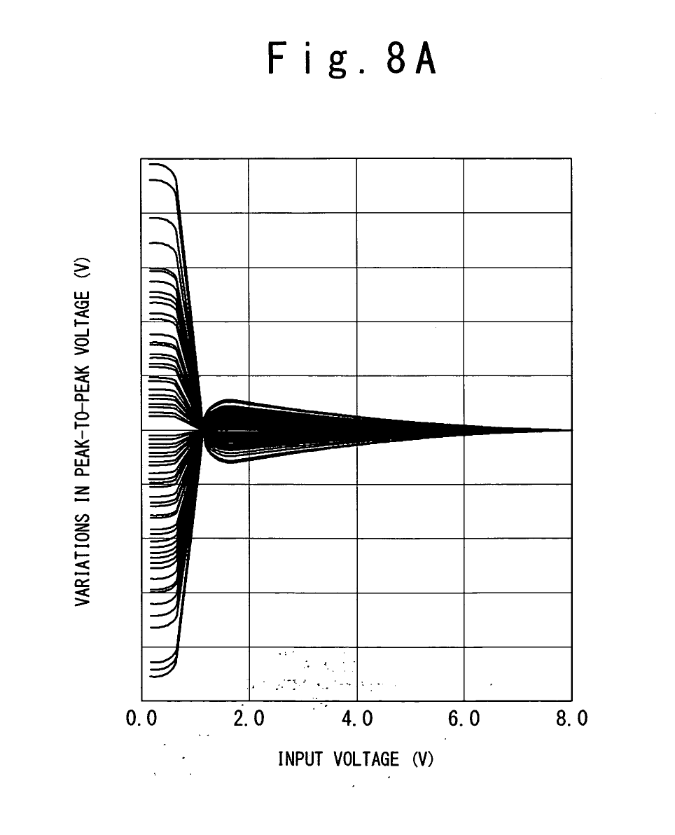

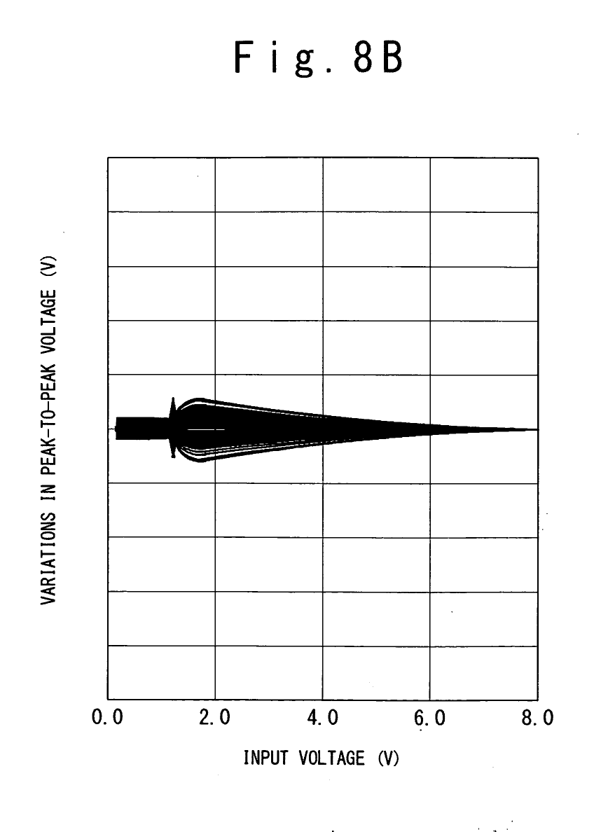

FIGS. 8A and 8B are graphs showing the simulation results of the peak-to-peak voltage variations for the conventional circuit shown in FIG. 1 and the source amplifier 25 of this embodiment. In FIGS. 8A and 8B, the horizontal axis indicates the input voltage, and the vertical axis indicates the peak-to-peak voltage variations. The conventional circuit in FIG. 1 exhibits increased peak-to-peak voltage variations in the voltage ranges close to the negative power source voltage VSS and the positive power source voltage VDD. On the other hand, the source amplifier 25 of this embodiment exhibits reduced peak-to-peak voltage variations in those voltage ranges, similarly to the middle voltage range. As thus discussed, the source amplifier 25 of this embodiment effectively achieves improved peak-to-peak voltage variations.

In this embodiment, the PMOS source followers 11, 13 and the NMOS source followers 12 and 14 in the input level conversion circuits 4 and 5 may stop operating when they are disconnected from the input node IN11 and IN12. Such operations are preferable in terms of the decrease in the power consumption of the source amplifier 25. Specifically, when the input switches SW11 and SW12 connect the input nodes IN11 and IN12 to the PMOS source followers 11 and 13, respectively (for example, when the polarity signal POL is “L”), the operations of the bias current sources I14 and I16 of the NMOS source followers 12, 14 are stopped. On the other hand, when the input switches SW11 and SW12 connect the input nodes IN11 and IN12 to the NMOS source followers 12 and 14, respectively (for example, when the polarity signal POL is “H”), the operations of the bias current sources I13 and I15 of the PMOS source followers 11 and 13 are stopped. Such operation can be achieved by on-off controls of the bias current sources I13 to I16 in response to the polarity signal POL, for example.

### Second Embodiment

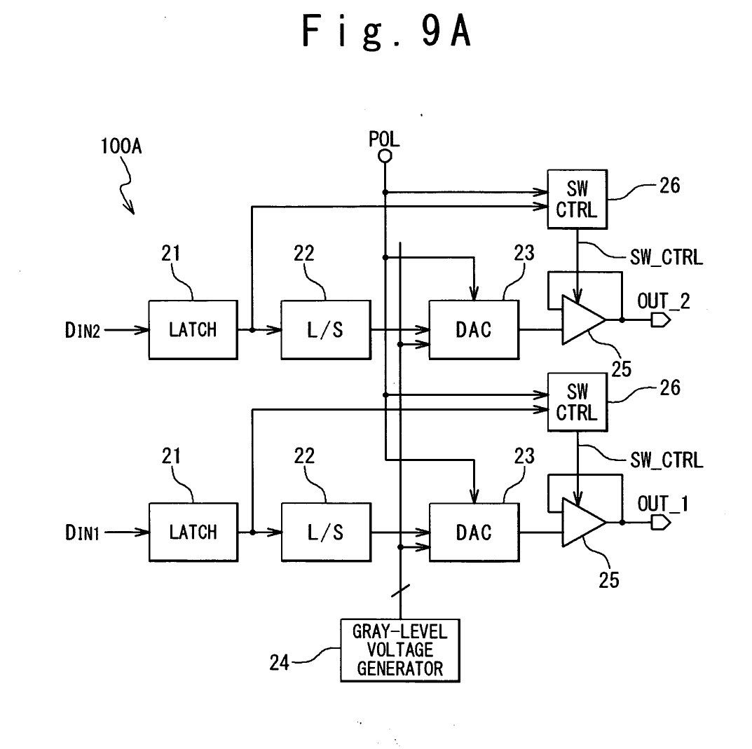

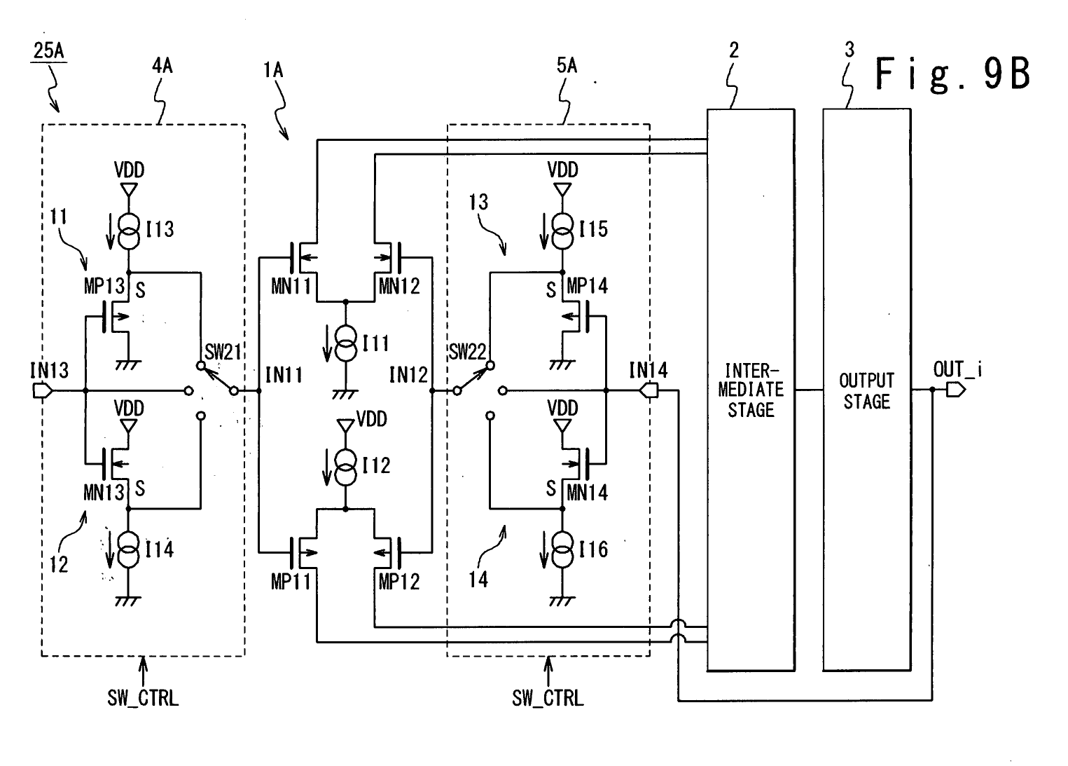

FIG. 9A is a circuit diagram showing an exemplary configuration of a source driver 100A in a second embodiment of the present invention, and FIG. 9B is a circuit diagram showing an exemplary configuration of a source amplifier 25A in the second embodiment. In the second embodiment, the source driver 100A and the source amplifier 25A integrated therein are configured to provide the input level conversion only in the voltage ranges close to the negative power source voltage VSS and the positive power source voltage VDD; the source amplifier 25A does not provide input level conversion in the middle voltage range.

Specifically, as shown in FIG. 9A, the source driver 100A is provided with a switch control circuit 26. The switch control circuit 26 generates a switch control signal SW_CTRL for controlling input switches SW21 and SW22 in the input stage 1A in the source amplifier 25A, in response to the pixel data D_{IN} latched by the latches 21 and the polarity signal POL.

The source amplifier 25A differs from the source amplifier 25 in the first embodiment in that the input switches SW21 and SW22 have functions for providing direct connections between the input nodes IN11 and IN12 to the input terminals IN13 and IN14, respectively as shown in FIG. 9B. In detail, the input switch SW21 connects the input node IN11 to one of the input terminal IN13, the PMOS source follower 11 and the NMOS source follower 12, in response to the switch control signal SW_CTRL outputted by the switch control circuit 26. On the other hand, the input switch SW22 connects the input node IN12 to one of the input terminal IN14, the PMOS source follow 13 and the NMOS source follower 14, in response to the switch control signal SW_CTRL. Since the switch control signal SW_CTRL is generated in response to the pixel data D_{IN} and the polarity signal POL as described above, the input switches SW21 and SW22 are controlled in response to the pixel data D_{IN} and the polarity signal POL.

In the following, a description is given of the operation of the source amplifier 25A of this embodiment. Hereafter, the operation of the source amplifier 25A is described which outputs a positive drive voltage when the polarity signal POL is “H” and outputs a negative drive voltage when the polarity signal POL is “L”, similarly to the first embodiment.

In this embodiment, the states of the input switches SW21 and SW22 are switched in response to the input voltage VIN13 inputted to the input voltage VIN13. When the input voltage VIN13 is a voltage close to the negative power source voltage VSS, (more specifically, when the input voltage VIN13 is lower than a standard voltage V_{STD1}), the input switches SW21, and SW22 connect the input nodes IN11 and IN12 to the sources of the PMOS transistors MP13 and MP14 in the PMOS source followers 13 and 14, respectively. Here, the standard voltage V_{STD1} is a predetermined voltage, which is lower than the voltage VDD/2 and equal to or higher than VT(MN11)+VDS(I11). In one embodiment, the standard voltage V_{STD1} is adjusted as follows:

V_{STD1}=VT(MN11)+VDS(I11).

When the input nodes IN11 and IN12 are connected to the sources of the PMOS transistors MP13 and MP14, respectively, a voltage that is higher than the voltage of the input terminal IN13 (input voltage VIN13) by the threshold voltage VT(MP13) of the PMOS transistor MP13 is supplied to the input node IN11, and a voltage that is higher than the voltage of the input terminal IN14 (input voltage VIN14) by the threshold voltage VT(MP14) of the PMOS transistor MP14 is supplied to the input node IN12.

When the input voltage VIN13 is in the middle voltage range (more specifically, when the input voltage VIN13 is higher than the standard voltage V_{STD1} and lower than a predetermined standard voltage V_{STD2} (>VDD/2)), on the other hand, the input switches SW21 and SW22 directly connect the input nodes IN11 and IN12 to the input terminals IN13 and IN14, respectively. In this case, the voltage of the input terminal IN13 (input voltage VIN13) is supplied to the input node IN11 as it is, and the voltage of the input terminal IN14 (input voltage VIN14) is supplied to the input node IN12 as it is.

Also, when the input voltage VIN13 is a voltage close to the positive power source voltage VDD, (more specifically, when the input voltage VIN13 is higher than the standard voltage V_{STD2}), the input switches SW21 and SW22 connect the input nodes IN11 and IN12 to the sources of the NMOS transistors MN13 an MN14 in the NMOS source followers 12 and 14, respectively.

Here, the standard voltage V_{STD2} is a predetermined voltage, which is higher than the voltage VDD/2 and equal to or lower than VDD−VDS(I12)−|VT(MP11)|. In one embodiment, the standard voltage V_{STD2} is adjusted as follows:

V_{STD1}=VDD−VDS(I12)−|VT(MP11)|,

When the input nodes IN11 and IN12 are connected to the sources of the NMOS transistors MN13 and MN14, respectively, a voltage that is lower than the voltage of the input terminal IN13 (input voltage VIN13) by the threshold voltage VT(MN13) of the NMOS transistor MN13 is supplied to the input node IN11, and a voltage that is lower than the voltage of the input terminal IN14 (input voltage VIN14) by the threshold voltage VT(MN14) of the PMOS transistor MP14 is supplied to the input node IN12.

Here, the states of the input switches SW21 and SW22 may be determined in response to the polarity signal POL and the pixel data D_{IN}, since the input voltage VIN13 depends on the value of the pixel data D_{IN}. That is, when the polarity signal POL is “L” and the pixel data D_{IN} have a value corresponding to the gray-level voltage lower than the standard voltage V_{STD1}, the input switches SW21 and SW22 connect the input nodes IN11 and IN12 to the sources of the PMOS transistors MP13 and MP14 in the PMOS source followers 11 and 13, respectively. When the polarity signal POL is “H” and the pixel data D_{IN} have a value corresponding to the gray-level voltage higher than the standard voltage V_{STD2}, on the other hand, the input switches SW21 and SW22 connect the input nodes IN11 and IN12 to the sources of the NMOS transistors MN13 and MN14 in the NMOS source followers 12 and 14, respectively. When any of the above-described conditions is not satisfied, the input switches SW21 and SW22 directly connect the input nodes IN11 and IN12 to the input terminals IN13 and IN14, respectively.

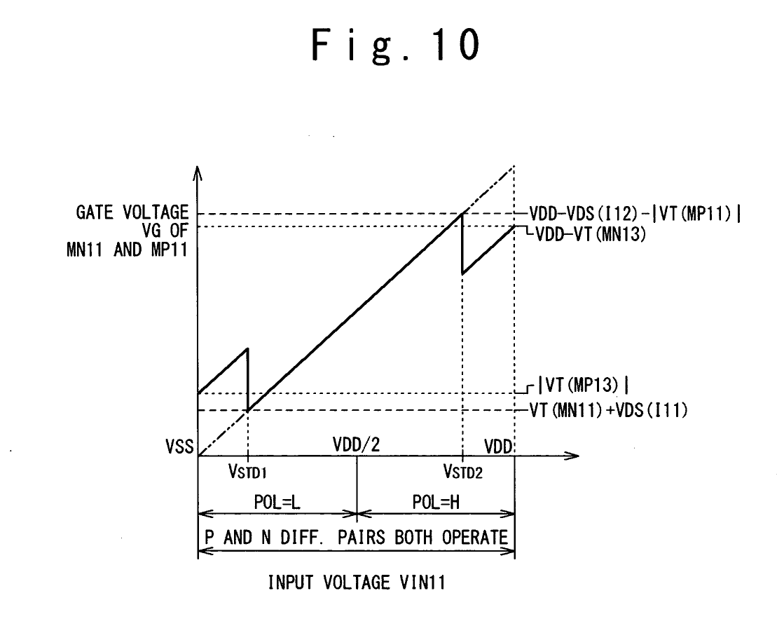

FIG. 10 is a graph showing an exemplary relation between the input voltage VIN13 and the gate voltages VG of the NMOS transistor MN11 and the PMOS transistor MP11. When the input voltage VIN13 is close to the negative power source voltage VSS (specifically, VIN13<V_{STD1}), the gate voltages of the NMOS transistor MN11 and the PMOS transistor MP11 are increased up to VIN13+|VT(MP13)|.

When the input voltage VIN13 is in the middle voltage range (specifically, V_{STD1}≦VIN13≦V_{STD2}), the input switch SW21 directly connects the input node IN11 to the input terminal IN13 and the gate voltages of the NMOS transistor MN11 and the PMOS transistor MP11 coincide with the VIN13.

Moreover, when the input voltage VIN13 is close to the positive power source voltage VDD (specifically, VIN 13>VDD−VDS(I12)−|VT(MP11)|, the gate voltages of the NMOS transistor MN11 and the PMOS transistor MP11 are decreased down to VIN13−VT(MN13).

In any case, the gate voltages of the NMOS transistor MN11 and the PMOS transistor MP11 are between the lower limit value (indicated by the lower dotted line) at which the NMOS transistor MN11 operates and the upper limit value (indicated by the upper dotted line) at which the PMOS transistor MP11 operates, even when the input voltage VIN13 has any voltage level between the negative power source voltage VSS and the positive power source voltage VDD. That is, in this embodiment, both of the NMOS differential pair and the PMOS differential pair can operate irrespectively of the value of the input voltage VIN13. This implies that the source amplifier 25 of this embodiment exhibits improved peak-to-peak voltage variations, even when the input voltage VIN13 has any voltage level in the voltage range between the negative power source voltage VSS and the positive power source voltage VDD.

In addition, the configuration of the source amplifier of this embodiment has an advantage that the influences caused by the property difference between the PMOS transistors MP13 and MP14 and the property difference between the NMOS transistors MN13 and MN14 can be reduced. In detail, the pair of the PMOS transistors MP13 and MP14 and the pair of the NMOS transistors MN13 and MN14 also operate as a differential pair. Thus, the differential pairs may cause small input-to-output offsets. In this embodiment, in the middle voltage range, the input terminal IN13 and the input node IN11 are directly connected and the input terminal IN14 and the input node IN12 are directly connected. This effectively reduces the influences caused by the pair of the PMOS transistors MP13 and MP14 and the pair of the NMOS transistors MN13 and MN14. Consequently, the input-to-output offset in the middle voltage range is reduced, and the higher definition of the drive voltage is attained.

It should be noted that, also in the second embodiment, the operations of the PMOS source followers 11, 13 and the NMOS source followers 12 and 14 in input level conversion circuits 4A and 5A may be stopped when they are disconnected to the input nodes IN11 and IN12. The above-described operations are preferable in order to decrease the power consumption of the source amplifier 25A. Specifically, when the input switches SW21 and SW22 connect the input nodes IN11 and IN12 to the PMOS source followers 11 and 13, respectively, the operations of the bias current sources I14 and I16 of the NMOS source followers 12 and 14 are stopped. On the other hand, when the input switches SW21 and SW22 connect the input nodes IN11 and IN12 to the NMOS source followers 12 and 14, respectively, the operations of the bias current sources I13 and I15 of the PMOS source followers 11 and 13 are stopped. Also, when the input switches SW21 and SW22 directly connect the input nodes IN11 and IN12 to the input terminals IN13 and IN14, respectively, all of the operations of the bias current sources I13 to I16 are stopped. In any case, the on-off controls of the bias current sources I13 I16 may be achieved in response to the polarity signal POL and the pixel data D_{IN}.

### Third Embodiment

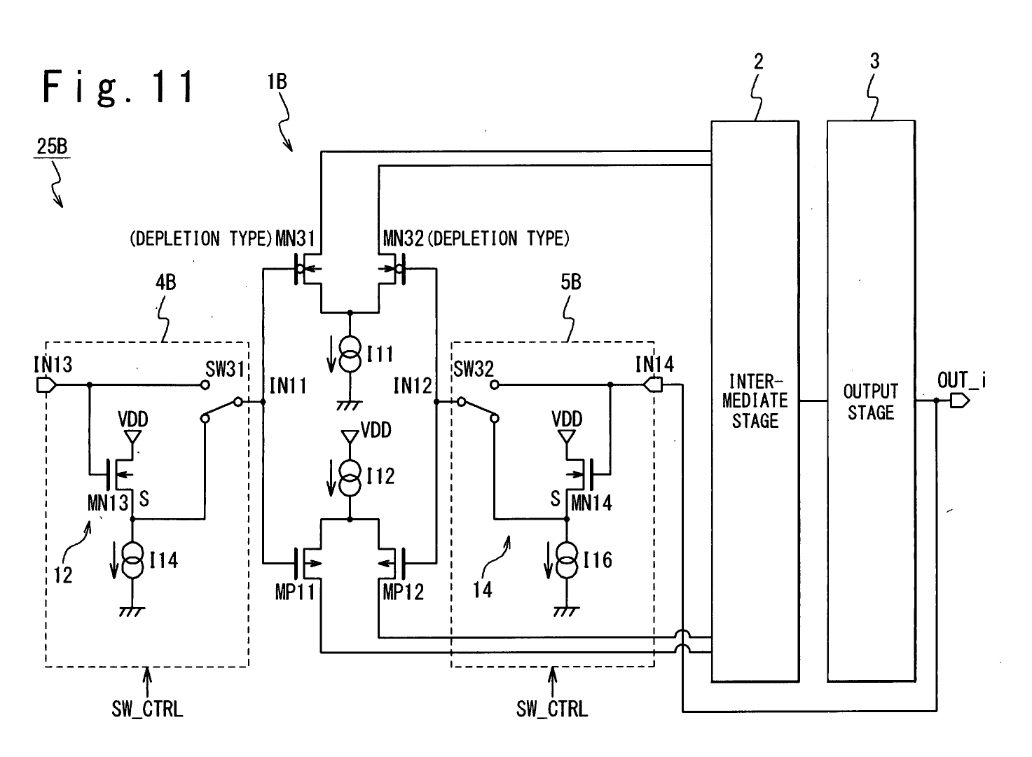

FIG. 11 is a circuit diagram showing an exemplary configuration of a source amplifier in a source driver of a third embodiment of the present invention. The source amplifier 25B of the third embodiment is configured similarly to the source amplifier 25 of the first embodiment. The most significant difference is that the NMOS differential pair of the input stage 1B is composed of depletion type NMOS transistors MN31 and MN32. The threshold voltage of the depletion type transistor is low as compared with the enhancement type transistor. This embodiment is described under an assumption that the threshold voltage of depletion type transistors is adjusted to −0.1 V; the threshold voltage of depletion type transistors may range from −0.2 V to 0 V.

It should be noted here that the NMOS differential pair formed by the depletion type NMOS transistors MN31 and MN32 can operate even when the input voltage is the negative power source voltage VSS.

In this embodiment, both of the NMOS differential pair and the PMOS differential pair operate, even when the input voltage is close to the negative power source voltage VSS. In this embodiment, the input level conversion is therefore carried out by input level conversion circuits 4B and 5B only when the input voltage is close to the positive power source voltage VDD.

In association with the use of the depletion type NMOS transistors MN31 and MN32 as the NMOS differential pair, the input stage 1B of the source amplifier 25B of this embodiment is configured as follows: The input level conversion circuit 4B is provided with an NMOS source follower 12 and an input switch SW31, and the input level conversion circuit 5B is provided with an NMOS source follower 14 and an input switch SW32. It should be noted here that, in this embodiment, the input level conversion circuits 4B and 5B do not incorporate any PMOS source follower. The input switch SW31 connects the input node IN11 to one of the input voltage VIN13 and the NMOS source follower 12, in response to the switch switching signal SW_CTRL. Similarly, the input switch SW32 connects the input node IN12 to one of the input terminal IN14 and the NMOS source follower 14, in response to the switch switching signal SW_CTRL. When the input node IN11 is connected to the source of the NMOS transistor MN13 in the NMOS source follower 12, the input voltage VIN11 of the input node IN11 is set to VIN13−VT(MN13). Similarly, when the input node IN12 is connected to the source of the NMOS transistor MN14 in the NMOS source follower 14, the input voltage VIN11 of the input node IN11 is set to VIN14−VT(MN14).

In the following, a description is given of the operation of the source amplifier 25B in this embodiment. Also in this embodiment, the states of the input switches SW31 and SW32 are switched in response to the input voltage VIN13 inputted to the input terminal IN13. When the input voltage VIN13 has a voltage level close to the positive power source voltage VDD (more specifically, when the polarity signal POL is “H” and the input voltage VIN13 is higher than the standard voltage V_{STD2}), the input switches SW31 and SW32 connect the input nodes IN11 and IN12 to the sources of the NMOS transistors MN13 and MN14 in the NMOS source followers 12 and 14, respectively. Here, the standard voltage V_{STD2} is a predetermined voltage which is higher than the voltage VDD/2 and equal to or less than VDD−VDS(I12)−|VT(MP11)|. In one embodiment, the standard voltage V_{STD2} is adjusted as follows:

V_{STD1}=VDD−VDS(I12)−|VT(MP11)|.

When the input nodes IN11 and IN12 are connected to the sources of the NMOS transistors MN13 and MN14, respectively, a voltage that is lower than the voltage of the input terminal IN13 (input voltage VIN13) by the threshold voltage VT(MN13) of the NMOS transistor MN13 is supplied to the input node IN11, and a voltage that is lower than the voltage of the input terminal IN14 (input voltage VIN14) by the threshold voltage VT(MN14) of the PMOS transistor MP14 is supplied to the input node IN12.

When the input voltage VIN13 is in the voltage range close to the negative power source voltage VSS or in the middle voltage range (more specifically, when the input voltage VIN13 is lower than the predetermined standard voltage V_{STD2}), on the other hand, the input switches SW31 and SW32 directly connect the input nodes IN11 and IN12 to the input terminals IN13 and 14, respectively. In this case, the voltage of the input terminal IN13 (input voltage VIN13) is supplied as it is to the input node IN11, and the voltage of the input terminal IN14 (input voltage VIN14) is supplied as it is to the input node IN12.

Also in the third embodiment, the states of the input switches SW31 and SW32 may be determined in response to the polarity signal POL and the pixel data D_{IN} That is, when the polarity signal POL is “H” and the pixel data D_{IN} has a value corresponding to the gray-level voltage higher than the standard voltage V_{STD2}, the input switches SW31 and SW32 connect the input nodes IN11 and IN12 to the sources of the NMOS transistors MN13 and MN14 in the NMOS source followers 12 and 14, respectively. Otherwise, the input switches SW31 and SW32 directly connect the input nodes IN11 and IN12 to the input terminals IN13 and IN14, respectively.

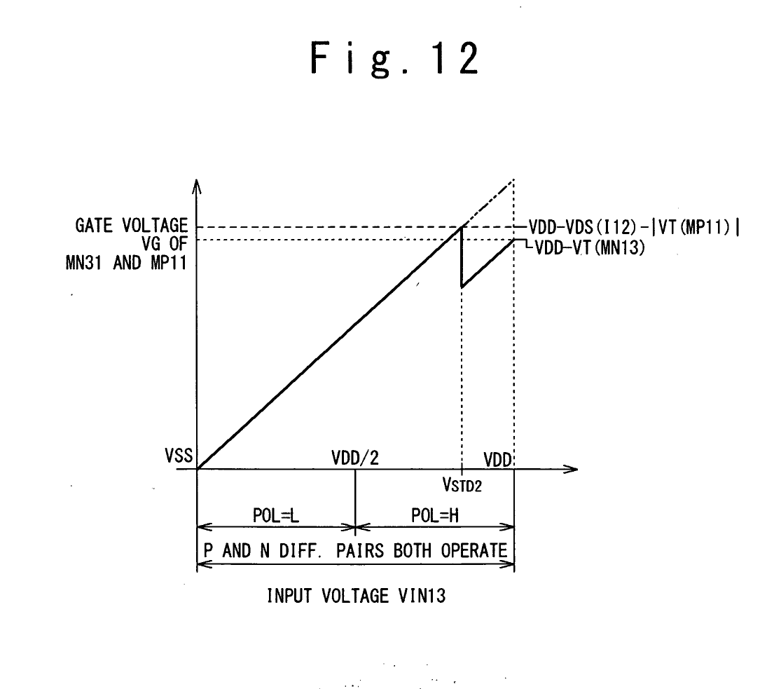

FIG. 12 is a graph showing an exemplary relation between the input voltage VIN13 and the gate voltages VG of the NMOS transistor MN31 and the PMOS transistor MP11, in the third embodiment. It should be noted here that FIG. 12 shows the operation for a case that the standard voltage V_{STD2} is VDD−VDS(I12)−|VT(MP11)|.

When the input voltage VIN13 is close to the positive power source voltage VDD (specifically, VIN13>V_{STD2}), the input switches SW31 and SW32 connect the input nodes IN11 and IN12 to the sources of the NMOS transistors MN13 and MN14 in the NMOS source followers 12 and 14, respectively. As a result the gate voltage of the PMOS transistor MP11 is decreased to VIN31−VT(MN13). Since the PMOS transistor MP11 is an enhancement-type PMOS transistor, therefore the PMOS transistor MP11 may be hard to operate when the gate voltage is close to the positive power source voltage VDD; however, the gate voltage of the PMOS transistor MP11 is decreased down to VIN31−VT(MN13) in this embodiment and this actually allows the PMOS transistor MP11 to operate.

When the input voltage VIN13 is close to the negative power source voltage VSS or in the middle voltage range (more specifically, VIN13≦V_{STD2}), on the other hand, the input voltage VIN13 is directly applied to the gates of the NMOS transistor MN31 and the PMOS transistor MP11. Since the NMOS transistor MN31 is a depletion-type NMOS transistor, the NMOS transistor MN31 can operate, even when the input voltage VIN13 is close to the negative power source voltage VSS.

That is, the use of the depletion type NMOS transistors MN31 and MN32 in the NMOS differential pair effectively causes the same effects as the first and second embodiments in the third embodiment without using any PMOS source follower.

When depletion-type NMOS transistors are used as the NMOS transistors MN31 and MN32 in the NMOS differential pair, application of a gate voltage close to the positive power source voltage VDD may cause a problem in establishing drain-to-source voltages of the NMOS transistors MN31 and MN32. This is because the source voltage may be higher than the positive power source voltage VDD, since the NMOS transistors MN31 and MN32 have a negative threshold voltage. In general, a drain-to-source voltage of an overdrive voltage (Vov) or higher is required in order to stably operate an NMOS transistor. Thus, as for the source voltage VS(MN31) of the NMOS transistor MN31, the following equation must be established:

VS(MN31)<VDD−VDS(MP43)−Vov(MN31), (3)

where VDS(MP43) is the drain-to-source voltage of the PMOS transistor MP43 that functions as the active load at the intermediate stage 2 (see FIG. 1). When the gate voltage of the NMOS transistor MN31 is close to the positive power source voltage VDD, the source amplifier 25B may not stably operate, since the source voltage VS(MN31) of the NMOS transistor MN31 does not satisfy the condition of equation (3). One may consider that this leads to deteriorations in the input-to-output offset and the peak-to-peak voltage variations.

In the circuit configuration in FIG. 11, however, the increase in the source voltage VS(MN31) of the NMOS transistor MN31 does not cause a serious problem, because the gate voltage of the NMOS transistor MN31 is decreased to VIN13−VT(MN13). The NMOS transistor MN31 stably operates even when the input voltage VIN13 is close to the positive power source voltage VDD.

It should be noted that the operations of the NMOS source followers 12 and 14 in the input level conversion circuits 4B and 5B may be stopped also in the third embodiment, when the NMOS source followers 12 and 14 are disconnected from the input nodes IN11 and 12, respectively. Such operations are preferable for decreasing the power consumption of the source amplifier 25B. More specifically, the operations of the bias current sources I14 and I16 of the NMOS source followers 12 and 14 may be stopped when the input switches SW31 and SW32 directly connect the input nodes IN11 and IN12 to the input terminals IN13, 14, respectively. Such operations may be attained through on-off controls of the bias current sources I14 and I16 in response to the polarity signal POL and the pixel data D_{IN}.

### Fourth Embodiment

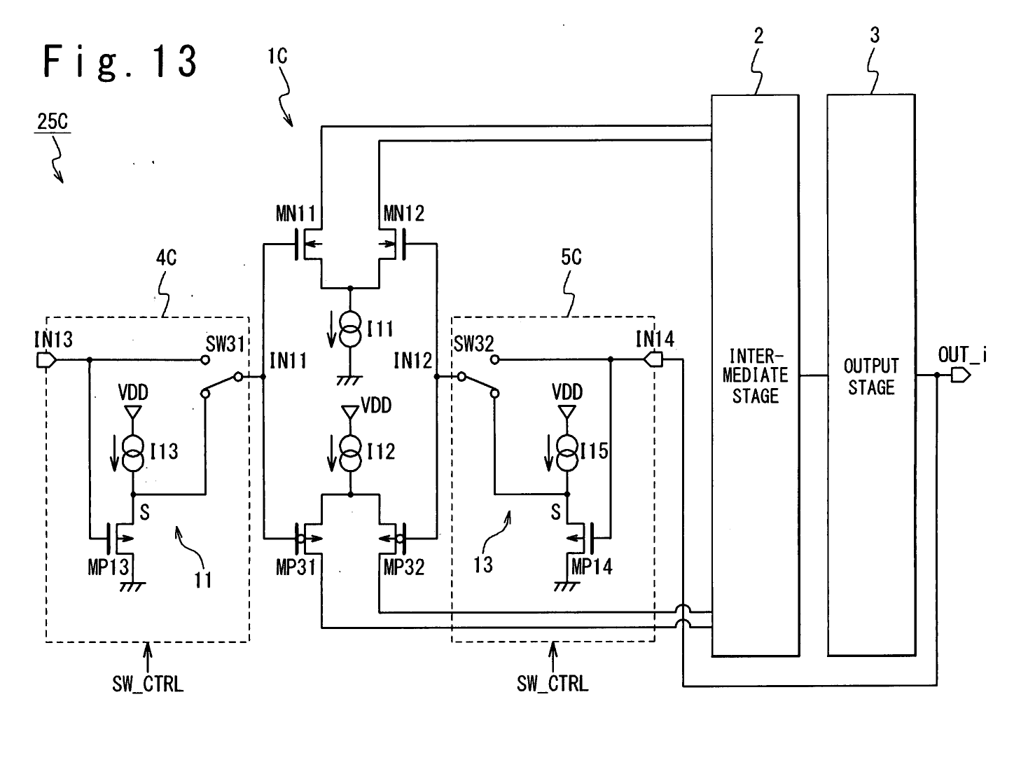

FIG. 13 is a circuit diagram showing an exemplary configuration of a source amplifier in a source driver of a fourth embodiment of the present invention. The source amplifier 25C of the fourth embodiment is configured similarly to the source amplifier 25B in the third embodiment. The difference is that depletion type PMOS transistors MP31 and MP32 are used as the PMOS differential pair within the input stage 1C, in place of the depletion type NMOS transistors MN31 and MN32 of the NMOS differential pair. In this case, the input level conversion circuit 4C is provided with a PMOS source follower 11 and an input switch SW31, and the input level conversion circuit 5C is provided with a PMOS source follower 13 and an input switch SW32.

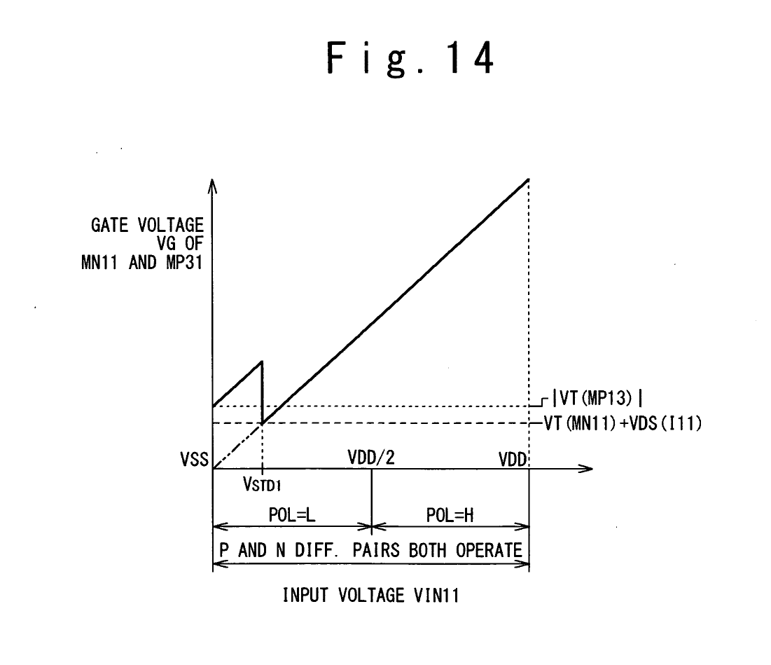

FIG. 14 is a graph showing an exemplary relation between the input voltage VIN13 and the gate voltages VG of the NMOS transistor MN11 and the PMOS transistor MP31 in the fourth embodiment.

When the input voltage VIN13 is close to the negative power source voltage VSS (specifically, VIN13<V_{STD1}), the input switches SW31 and SW32 connect the input nodes IN11 and IN12 to the sources of the PMOS transistors MP13 and MP14 in the PMOS source followers 11 and 13, respectively. Here, FIG. 14 shows the operation for a case that the standard voltage V_{STD1} is VT(MN11)+VDS(I11). As a result, the gate voltage of the NMOS transistor MN11 is increased up to VIN31+|VT(MP13)|. Since the NMOS transistor MN11 is an enhancement-type NMOS transistor, the NMOS transistor MN11 may be hard to operate when the gate voltage is close to the negative power source voltage VSS; however, the NMOS transistor MN11 actually operate, since the gate voltage of the NMOS transistor MN11 is increased up to VIN31+|VT(MP13)|.

When the input voltage VIN13 is close to the positive power source voltage VDD or in the middle voltage range (specifically, VIN13≧V_{STD1}), on the other hand, the input voltage VIN13 is directly applied to the gates of the NMOS transistor MN11 and the PMOS transistor MP31. The PMOS transistor MP31 is the depletion type transistor and thus the PMOS transistor MP31 can operate even when the input voltage VIN13 is close to the positive power source voltage VDD.

That is, the use of the depletion type PMOS transistors MP31 and MP32 as the PMOS differential pair effectively causes the same effects as the first and second embodiments without using any NMOS source follower.

Also in the fourth embodiment, the states of the input switches SW31 and SW32 may be switched in response to the polarity signal POL and the pixel data D_{IN}. Specifically, when the polarity signal POL is “L” and the pixel data D_{IN} has a value corresponding to the gray-level voltage lower than the standard voltage V_{STD1}, the input switches SW31 and SW32 connect the input nodes IN11 and IN12 to the sources of the PMOS transistors MP13 and MP14 in the PMOS source followers 11 and 13, respectively. Otherwise, the input switches SW31 and SW32 directly connect the input nodes IN11 and IN12 to the input terminals IN13 and IN14, respectively.

Also in the fourth embodiment, the operations of the PMOS source followers 11 and 13 in the input level conversion circuits 4C and 5C may be stopped, when the PMOS source followers 11 and 13 in the input level conversion circuits 4C and 5C are disconnected from the input nodes IN11 and IN12, respectively. Such operations are preferable in order to decrease the power consumption of the source amplifier 25C. Specifically, when the input switches SW31 and SW32 directly connect the input nodes IN11 and IN12 to the input terminals IN13 and IN14, respectively, the operations of the bias current sources I13 and I15 of the PMOS source followers 11 and 13 are stopped. Such operations may be attained through on-off controls of the bias current sources I13 and I15 in response to the polarity signal POL and the pixel data D_{IN}.

It would be apparent that the present invention is not limited to the above embodiments, but may be modified and changed without departing from the scope of the invention. For example, although the second to fourth embodiments are described to recite that the gray-level voltages supplied to the source amplifiers 25A to 25C are judged from the polarity signal POL and the pixel data D_{IN} in controlling the operations of the input switches SW21, SW22, SW31 and SW32, the gray-level voltages supplied to the source amplifiers 25A to 25C may be directly measured and the operations of the input switches SW21, SW22, SW31 and SW32 are controlled in response to the measured gray-level voltages. It should be noted, however, that the configuration in which the gray-level voltages supplied to the source amplifiers 25A to 25C are judged from the polarity signal POL and the pixel data D_{IN} is preferable in view of the easiness of data processing.

What is claimed is:

1. A source driver for driving a liquid crystal display panel, comprising:
a D/A converter outputting a gray-level voltage corresponding to pixel data; and
a source amplifier outputting a drive voltage in response to said gray-level voltage,
wherein said source amplifier includes:
an NMOS differential pair including first and second NMOS transistors;
a PMOS differential pair including first and second PMOS transistors;
an output circuitry outputting a drive voltage in response to currents flowing through said NMOS and PMOS differential pairs;
a first input level conversion circuit generating a first level-converted voltage through input level conversion on said gray-level voltage in response to said gray-level voltage and/or a polarity of said drive voltage defined with respect to a common level on an opposite electrode of said liquid crystal display panel and feeding said first level-converted voltage to gates of said first NMOS transistor and said first PMOS transistor; and
a second input level conversion circuit generating a second level-converted voltage through input level conversion on said drive voltage in response to said gray-level voltage and/or the polarity of said drive voltage and feeding said second level-converted voltage to gates of said second NMOS transistor and said second PMOS transistor.

2. The source driver according to claim 1, wherein, when the polarity of said drive voltage is negative with respect to said common level, said first input level conversion circuit feeds a voltage higher than said gray-level voltage by a first predetermined voltage as said first level-converted voltage to the gates of said first NMOS transistor and said first PMOS transistor, and said second input level conversion circuit feeds a voltage higher than said drive voltage by said first predetermined voltage as said second level-converted voltage to the gates of said second NMOS transistor and said second PMOS transistor, and
wherein, when the polarity of said drive voltage is positive with respect to said common level, said first input level conversion circuit feeds a voltage lower than said gray-level voltage by a second predetermined voltage as said first level-converted voltage to the gates of said first NMOS transistor and said first PMOS transistor, and said second input level conversion circuit feeds a voltage lower than said drive voltage by said second predetermined voltage as said second level-converted voltage to the gates of said second NMOS transistor and said second PMOS transistor.

3. The source driver according to claim 1, wherein said source amplifier includes an input terminal receiving said gray-level voltage and an amplifier output outputting said drive voltage,
wherein said first input level conversion circuit includes:
a first PMOS source follower having an input connected to said input terminal;
a first NMOS source follower having an input connected to said input terminal; and
a first input switch responsive to the polarity of said drive voltage for connecting one of outputs of said first PMOS source follower and said first NMOS source follower to the gates of said first NMOS transistor and said first PMOS transistor,
wherein said second input level conversion circuit includes:
a second PMOS source follower having an input connected to said amplifier output;
a second NMOS source follower having an input connected to said amplifier output; and
a second input switch responsive to the polarity of said drive voltage for connecting one of outputs of said second PMOS source follower and said second NMOS source follower to the gates of said second NMOS transistor and said second PMOS transistor.

4. The source driver according to claim 3, wherein an operation of a disconnected one of said first PMOS source follower and said first NMOS source follower from the gates of said first NMOS transistor and said first PMOS transistor is stopped, and
wherein an operation of a disconnected one of said second PMOS source follower and said second NMOS source follower from the gates of said second NMOS transistor and said second PMOS transistor is stopped.

5. The source driver according to claim 1, wherein, when said gray-level voltage is lower than a first standard voltage, said first input level conversion circuit feeds a voltage higher than said gray-level voltage by a first predetermined voltage as said first level-converted voltage to the gates of said first NMOS transistor and said first PMOS transistor and said second input level conversion circuit feeds a voltage higher than said drive voltage by said first predetermined voltage as said second level-converted voltage to the gates of said second NMOS transistor and said second PMOS transistor, and
wherein, when said gray-level voltage is lower than a second standard voltage which is higher than said first standard voltage, said first input level conversion circuit feeds a voltage lower than said gray-level voltage by a second predetermined voltage as said first level-converted voltage to the gates of said first NMOS transistor and said first PMOS transistor and said second input level conversion circuit feeds a voltage lower than said drive voltage by said second predetermined voltage as said second level-converted voltage to the gates of said second NMOS transistor and said second PMOS transistor, and
wherein, when said gray-level voltage is higher than said first standard voltage and lower than said second standard voltage, said first input level conversion circuit feeds said gray-level voltage to the gates of said first NMOS transistor and said first PMOS transistor and said second input level conversion circuit feeds said drive voltage to the gates of said second NMOS transistor and said second PMOS transistor.

6. The source driver according to claim 1, wherein said source amplifier includes an input terminal receiving said gray-level voltage and an amplifier output outputting said drive voltage, wherein said first input level conversion circuit includes:
a first PMOS source follower having an input connected to said input terminal;
a first NMOS source follower having an input connected to said input terminal; and
a first input switch responsive to said gray-level voltage for connecting one of outputs of said first PMOS source follower and said first NMOS source follower to the gates of said first NMOS transistor and said first PMOS transistor,
wherein said second input level conversion circuit includes:
a second PMOS source follower having an input connected to said amplifier output;
a second NMOS source follower having an input connected to said amplifier output;
a second input switch responsive to said gray-level voltage for connecting one of outputs of said second PMOS source follower and said second NMOS source follower to the gates of said second NMOS transistor and said second PMOS transistor.

7. The source driver according to claim 6, wherein an operation of a disconnected one of said first PMOS source follower and said first NMOS source follower from the gates of said first NMOS transistor and said first PMOS transistor is stopped, and
wherein an operation of a disconnected one of said second PMOS source follower and said second NMOS source follower from the gates of said second NMOS transistor and said second PMOS transistor is stopped.

8. The source driver according to claim 1, wherein said first and second NMOS transistors are depletion-type NMOS transistors,
wherein, when said gray-level voltage is higher than a first standard voltage, said first input level conversion circuit feeds a voltage lower than said gray-level voltage by a second predetermined voltage as said first level-converted voltage to the gates of said first NMOS transistor and said first PMOS transistor and said second input level conversion circuit feeds a voltage lower than said drive voltage by said second predetermined voltage as said second level-converted voltage to the gates of said second NMOS transistor and said second PMOS transistor, and
wherein, when said gray-level voltage is lower than said first standard voltage, said first input level conversion circuit feeds said gray-level voltage to the gates of said first NMOS transistor and said first PMOS transistor and said second input level conversion circuit feeds said drive voltage to the gates of said second NMOS transistor and said second PMOS transistor.

9. The source driver according to claim 8, wherein said source amplifier includes an input terminal receiving said gray-level voltage and an amplifier output outputting said drive voltage,
wherein said first input level conversion circuit includes:
a first NMOS source follower having an input connected to said input terminal; and
a first input switch responsive to said gray-level voltage for connecting one of said input terminal and an output of said first NMOS source follower to the gates of said first NMOS transistor and said first PMOS transistor,
wherein said second input level conversion circuit includes:
a second NMOS source follower having an input connected to said amplifier output; and
a second input switch responsive to said gray-level voltage for connecting one of said input terminal and an output of said second NMOS source follower to the gates of said first NMOS transistor and said first PMOS transistor.

10. The source driver according to claim 9, wherein an operation of said first NMOS source follower is stopped when said first NMOS source follower is disconnected from the gates of said first NMOS transistor and said first PMOS transistor, and
wherein an operation of said second NMOS source follower is stopped when said second NMOS source follower is disconnected from the gates of said second NMOS transistor and said second PMOS transistor.

11. The source driver according to claim 1, wherein said first and second PMOS transistors are depletion-type PMOS transistors,
wherein, when said gray-level voltage is lower than a first standard voltage, said first input level conversion circuit feeds a voltage higher than said gray-level voltage by a first predetermined voltage as said first level-converted voltage to the gates of said first NMOS transistor and said first PMOS transistor and said second input level conversion circuit feeds a voltage higher than said drive voltage by said second predetermined voltage as said second level-converted voltage to the gates of said second NMOS transistor and said second PMOS transistor, and
wherein, when said gray-level voltage is higher than a first standard voltage, said first input level conversion circuit feeds said gray-level voltage to the gates of said first NMOS transistor and said first PMOS transistor and said second input level conversion circuit feeds said drive voltage to the gates of said second NMOS transistor and said second PMOS transistor.

12. The source driver according to claim 11, wherein said source amplifier includes an input terminal receiving said gray-level voltage and an amplifier output outputting said drive voltage,
wherein said first input level conversion circuit includes:
a first PMOS source follower having an input connected to said input terminal; and
a first input switch responsive to said gray-level voltage for connecting one of said input terminal and an output of said first PMOS source follower to the gates of said first NMOS transistor and said first PMOS transistor, and
wherein said second input level conversion circuit includes:
a second PMOS source follower having an input connected to said amplifier output; and
a second input switch responsive to said gray-level voltage for connecting one of said input terminal and an output of said second PMOS source follower to the gates of said first NMOS transistor and said first PMOS transistor.

13. The source driver according to claim 12, wherein an operation of said first PMOS source follower is stopped when said first PMOS source follower is disconnected from the gates of said first NMOS transistor and said first PMOS transistor, and
wherein an operation of said second PMOS source follower is stopped when said second PMOS source follower is disconnected from the gates of said second NMOS transistor and said second PMOS transistor.

14. A liquid crystal display device, comprising:
a liquid crystal display panel; and
a source driver driving said liquid crystal display panel,
wherein said source driver includes:
a D/A converter outputting a gray-level voltage corresponding to pixel data; and
a source amplifier outputting a drive voltage in response to said gray-level voltage,
wherein said source amplifier includes:
an NMOS differential pair including first and second NMOS transistors;
a PMOS differential pair including first and second PMOS transistors;
an output circuitry outputting a drive voltage in response to currents flowing through said NMOS and PMOS differential pairs;
a first input level conversion circuit generating a first level-converted voltage through input level conversion on said gray-level voltage in response to said gray-level voltage and/or a polarity of said drive voltage defined with respect to a common level on an opposite electrode of said liquid crystal display panel and feeding said first level-converted voltage to gates of said first NMOS transistor and said first PMOS transistor; and
a second input level conversion circuit generating a second level-converted voltage through input level conversion on said drive voltage in response to said gray-level voltage and/or the polarity of said drive voltage and feeding said second level-converted voltage to gates of said second NMOS transistor and said second PMOS transistor.
